(19) United States
(12) Patent Application Publication
(10) Pub. No.: US 2013/0170757 A1
(43) Pub. Date: Jul. 4, 2013

(54) METHOD FOR CREATING TEMPLATE FOR PATTERNMATCHING, AND IMAGE PROCESSING APPARATUS

(71) Applicants: Shinichi Shinoda, Hitachi (JP); Yasutaka Toyoda, Mito (JP); Yuichi Abe, Mito (JP); Mitsuji Ikeda, Hitachinaka (JP); Hiroyuki Ushiba, Hitachi (JP)

(72) Inventors: Shinichi Shinoda, Hitachi (JP); Yasutaka Toyoda, Mito (JP); Yuichi Abe, Mito (JP); Mitsuji Ikeda, Hitachinaka (JP); Hiroyuki Ushiba, Hitachi (JP)

(73) Assignee: HITACHI HIGH-TECHNOLOGIES CORPORATION, Tokyo (JP)

(21) Appl. No.: 13/807,666

(22) PCT Filed: May 13, 2011
(86) PCT No.: PCT/JP2011/002660

§ 371 Date: Mar. 25, 2013

(30) Foreign Application Priority Data
Jun. 29, 2010 (JP) 2010-147051
Jan. 19, 2011 (JP) 2011-008374

(51) Int. Cl. G06K 9/00

(52) U.S. Cl. CPC G06K 9/00
USPC 382/209

(57) ABSTRACT

Disclosed is a method for creating a template for the purpose of performing pattern matching on the basis of a template image having high contrast. Also disclosed is an image processing apparatus. In the method for creating the template, design data is partially extracted, and on the basis of the extracted partial region, the template for template matching is created. In the image processing apparatus, such method is performed. In the method and the apparatus, a density of edges that belong to a predetermined region in the design data equivalent to the region to be searched for in the template matching is obtained.

### TECHNICAL FIELD

The present invention relates to a method, an image processing apparatus, and a program for creating a template used for detecting a specific position, and particularly, to a method and the like for creating a template based on design data of a semiconductor device and the like.

### BACKGROUND ART

In a semiconductor measuring apparatus, conventional image recognition compares the same type of images, such as an image of an SEM (Scanning Electron Microscope) and an SEM image as well as an image of an optical microscope (OM) and an OM image. In recent years, an image recognition technique using design data has emerged, in which the design data and an SEM image are compared, and the design data and an OM image are compared.

In the comparison between the same type of images, contrast information can be used as effective information in the image recognition. However, the contrast information cannot be used as effective information in the comparison between images of different types, as in the comparison of the design data and the OM image. This is because the design data does not include contrast information as expressed in the OM image, and information of presence/absence of a pattern is just binary information. Therefore, even if the design data is compared with the OM image that is multi-valued information, a part with different contrast is generated, and the image recognition may not be successful.

A pattern that does not exist in the design data may be included in the OM image, and that situation cannot be handled, either. Consequently, a system for using only edges of design data to execute a matching process (see Patent Literature 1) is proposed. In this method, matching is performed only with the edges obtained from the design data, and correlation computation is ignored in other regions. This can handle inversion of the contrast and inclusion of a pattern that does not exist in the design data. To use information of contrast of an image, a method for using material information of patterns from design data to reflect reflectance and the like on each pattern to create multi-valued image information (see Patent Literature 2) is proposed as a method for using information other than the edges. According to the method, the information of the contrast can be used.

### CITATION LIST

### Patent Literature

PATENT LITERATURE 1: JP-A-2007-334702
PATENT LITERATURE 2: JP-A-2009-216398

### SUMMARY OF INVENTION

### Technical Problem

According to the method for selectively extracting an edge part to perform matching as described in Patent Literature 1, lower-layer pattern information that may become noise in the matching process can be selectively excluded to perform pattern matching. However, the edges obtained from a multi-valued OM image with contrast information have variations in the brightness, and the edges of a binary template image created from the design data do not have variations in the brightness. Therefore, the degree of coincidence between the two may be reduced.

Even if the image information is created from the design data by multiple values close to the OM image as described in Patent Literature 2, there is little effective information for comparison if the contrast of the image is low. Therefore, the image recognition may not succeed

Furthermore, there are various processes for manufacturing a semiconductor, such as exposure, development, etching, photoresist removal, and planarization, and the appearance of the OM image varies in each process. Therefore, even if the information of the contrast is used to create the image information from the design data by multiple values as described in Patent Literature 2, the appearance is different from the OM image depending on the process, and the image recognition may not succeed.

Hereinafter, a method and an image processing apparatus for creating a template for pattern matching for the purpose of performing pattern matching based on a template image having high contrast will be described. A method for creating a template for pattern matching and an image processing apparatus using the same for the purpose of performing pattern matching based on a step state of a pattern in a process will also be described.

### Solution to Problem

Proposed below as an aspect for attaining the purposes are: a method for creating a template for template matching, the template created by partially extracting part of design data, the template created based on the extracted partial region; and an apparatus that realizes the method for creating a template, wherein a density of edges that belong to a predetermined region (for example, a search region or a region specified by the template) in the design data equivalent to a region to be searched for in the template matching is obtained.

Proposed as a more specific aspect are a method and an apparatus that determine an edge density for the predetermined region and that select the predetermined region as a template region or a template candidate if the edge density satisfies a predetermined condition. For example, a region including a region with a high edge density and a region with a low edge density at a predetermined ratio is selected as a template region or a template candidate region.

Proposed below as another aspect for attaining the purposes are a method for creating a template for template matching from design data and an apparatus that realizes the method for creating a template, wherein process information related to a process of semiconductor manufacturing is used to obtain grayscale information of a multi-layer pattern of a region specified by the template.

### Advantageous Effects of Invention

According to the aspect, a template or a template candidate having high contrast can be extracted from design data. According to the other aspect, a template suitable for each process can be created.

### BRIEF DESCRIPTION OF DRAWINGS

FIG. 1 is a block diagram showing an apparatus configuration of an image processing apparatus that creates a template based on design data.

FIG. 2 is a diagram showing a relationship between steps of patterns and signal values.

FIG. 3 is a diagram showing an example of a template creating section.

FIG. 4 is a diagram showing an example of a drawing section.

FIG. 5 is a diagram showing an example of an edge density calculating section of pattern edges.

FIG. 6 is a diagram showing a summary of a computation process in a density detecting section.

FIG. 7 is a diagram showing an example of the edge density calculating section corresponding to a multi-layer pattern.

FIG. 8 is a diagram showing an example of a maximum value selecting section.

FIG. 9 is a diagram showing an example of a region selecting section.

FIG. 10 is a diagram showing an example of a sparse region detecting section.

FIG. 11 is a diagram showing a summary of a computation process in a white region detecting section.

FIG. 12 is a diagram showing an example of a dense region detecting section.

FIG. 13 is a diagram showing an example of a determining section.

FIG. 14 is a flow chart for explaining a detecting process of a template region position and a region size.

FIG. 15 is a diagram showing an example of an image creating section.

FIG. 16 is a diagram showing an example of the image creating section.

FIG. 17 is a block diagram showing an apparatus configuration of an image processing apparatus that creates a template based on design data.

FIG. 18 is a diagram showing a template setting example.

FIG. 19 is a diagram showing a summary of a processing flow of the image creating section.

FIG. 20 is a diagram showing a processing flow of a pattern edge synthetic image creating process.

FIG. 21 is a flow chart for explaining a processing step of a pattern edge multi-valued image creating step.

FIG. 22 is a flow chart for explaining a pattern synthetic image creation processing step.

FIG. 23 is a flow chart for explaining a processing step of a multi-valued template creating process.

FIG. 24 is a diagram for explaining an example of a semiconductor measuring system.

FIG. 25 is a schematic explanatory view of a scanning electron microscope.

FIG. 26 is a flow chart showing a recipe verifying process.

FIG. 27 is a flow chart showing a template automatic creation or template creation assisting process.

FIG. 28 is a block diagram showing an apparatus configuration of an image processing apparatus that creates a template based on design data and process information.

FIG. 29 is a diagram showing an example of a step estimating section.

FIG. 30 is a diagram showing an example of a region dividing section.

FIG. 31 is a diagram showing a summary of drawing images of patterns, edge detection results, and overlap edge detection results.

FIG. 32 is a diagram showing an example of a region division storage section.

FIG. 33 is a diagram showing an example of a grayscale correction calculating section.

FIG. 34 is a diagram showing an example of a grayscale information creating section.

FIG. 35 is a diagram showing a relationship between steps of multi-layer patterns and signal values.

FIG. 36 is a block diagram showing an apparatus configuration of an image processing apparatus that creates a template by receiving a step state from the outside.

FIG. 37 is a diagram showing an example of the grayscale correction calculating section.

FIG. 38 is a diagram showing a processing flow for creating a template.

FIG. 39 is a diagram showing a table example illustrating a relationship between pattern classification, manufacturing process information, and image processing conditions.

FIG. 40 is a diagram showing a table example illustrating a relationship between pattern conditions and pattern classification.

FIG. 41 is diagram for explaining an example of a computation processing apparatus included in a recipe creating apparatus.

FIG. 42 is a diagram for explaining an example of applying unique image processing to a plurality of different regions.

FIG. 43 is a flow chart showing a process of using two tables to set image processing conditions of an OM template.

FIG. 44 is a flow chart showing a process of creating a template for an OM image used for measurement and inspection after a manufacturing process based on an OM image obtained in a measuring and inspecting process after another manufacturing process.

### DESCRIPTION OF EMBODIMENTS

An image processing apparatus illustrated in embodiments described below relates to a method and an apparatus that detect a specific region based on information obtained from design data to create a multi-valued template. In a specific example of the image processing apparatus, a specific region is detected based on information on the basis of a density of pattern edges obtained from design data to create one or both of binary and multi-valued templates from the design data. An example of creating one or both of binary and multi-valued templates from design data based on information on the basis of a density of pattern edges obtained from the design data will also be described.

The present embodiments also describe setting of one or both of a coordinate position and a region size of a region used for a template of design data based on information of pattern edges obtained from the design data. An example of setting one or both of a coordinate position and a region size of a region used for a template of design data based on information on the basis of a density of pattern edges obtained from the design data will also be described. An example of changing one or both of already set coordinate position and region size of a region used for a template of design data based on information on the basis of a density of pattern edges obtained from the design data will also be described.

Also described is an example of an image processing apparatus including: storage means for storing design data; pattern edge density calculating means for obtaining information based on a density of pattern segments from the design data; template position adjusting means for obtaining a template region based on the information of the density of pattern edges obtained by the pattern edge density calculating means; and template creating means for creating a template based on the information obtained by the template position adjusting means.

An example of detecting a region including both a region with a sparse density of pattern segments and a region with a dense density of pattern segments based on information on the basis of a density of pattern segments obtained from design data and setting one or both of a coordinate position and a region size of the region used for a template will also be described. An example of displaying information based on a density of pattern edges obtained from design data will also be described. Also described is an example in which information based on a density of pattern edges obtained from design data is displayed, and a user sets a template region.

An example of forming one or both of binary and multi-valued templates will also be described. It is a feature that information based on a density of pattern edges obtained from design data is used to create one or both of binary and multi-valued templates. An example of obtaining pattern edges of each layer from design data and using information based on a density of pattern edges obtained by placing the pattern edges of the layers on top of each other to create one or both of binary and multi-valued templates will also be described.

An example of detecting a region including both a region with a sparse density of pattern segments and a region with a dense density of pattern segments based on information on the basis of a density of pattern segments obtained from design data to create one or both of binary and multi-valued templates will also be described. An example will also be described, in which information based on a density of pattern edges from design data is used, and smoothing means performs smoothing of information of a pattern edge image in creation of a multi-valued template.

Further described is an image creating method for using information based on a density of pattern edges obtained from design data to create one or both of binary and multi-valued templates and an image processing program for using information based on a density of pattern edges obtained from design data to create one or both of binary and multi-valued templates.

According to the embodiments, image processing can be applied to a pattern at a robust, high matching success rate.

In the following embodiments, a method and an apparatus that create a template based on information obtained from process information and design data will be described. In a specific example, design data and process information related to a manufacturing process are used to estimate a step state of a pattern of a region specified by the template to obtain grayscale information of each position in the template. An example in which the user sets process information related to a manufacturing process in creating a template for template matching will also be illustrated. Also described is an example, in which multi-layer patterns corresponding to a manufacturing process are used to divide a region specified by the template into a plurality of regions based on relative positions of patterns between layers of the multi-layer patterns, and process information related to the manufacturing process is used for each region to estimate a step state of the pattern to generate grayscale information of each position of each region.

Also described is an example, in which a plurality of image processing methods for obtaining grayscale information of each position in the template from design data are included, and process information related to a manufacturing process is used to switch output of the plurality of image processing methods. Also described is an example, in which the user can use a plurality of layers of a region specified by the template to change parameters for adjusting grayscale information of patterns of a plurality of regions classified based on relative positions of patterns between the layers.

An example of an image processing program for using information based on design data and process information related to a manufacturing process to create a template will also be described.

According to the embodiments, image processing can be applied to each process at a robust, high matching success rate.

Hereinafter, an example of acquiring density information of a pattern from design data to verify a template or create a template based on the density information will be described with reference to the drawings.

Hereinafter, an apparatus and a measurement inspection system including a pattern matching function for specifying a measuring or inspecting position based on template matching will be described with reference to the drawings. More specifically, an apparatus and a system including a critical dimension-scanning electron microscope (CD-SEM) that is a type of a measuring apparatus, as well as a computer program realized by the apparatus and the system will be described.

In the following description, a charged particle radiation apparatus will be illustrated as an apparatus that forms an image, and an example using an SEM will be described as a mode of the charged particle radiation apparatus. However, the arrangement is not limited to this, and for example, a focused ion beam (FIB) apparatus that applies an ion beam to a sample to scan the sample to form an image may be adopted as a charged particle radiation apparatus. However, an extremely high magnification is required for highly accurate measurement of an increasingly miniaturized pattern. Therefore, it is generally desirable to use the SEM that is superior to the FIB apparatus in terms of resolving power.

FIG. 24 is a schematic explanatory view of a measuring inspection system in which a plurality of measuring or inspecting apparatuses are connected to a network. In the system, a CD-SEM 2401 that mainly measures a pattern dimension of a semiconductor wafer, a photomask, or the like and a defect inspecting apparatus 2402 that applies an electron beam to a sample to acquire an image to extract a defect based on comparison of the image with a reference image registered in advance are connected to the network. A condition setting apparatus 2403 that sets a measurement position, a measurement condition, and the like on design data of a semiconductor device, a simulator 2404 that simulates the quality of a pattern based on the design data of the semiconductor device, a manufacturing condition of a semiconductor manufacturing apparatus, and the like, and a storage medium 2405 that stores layout data of the semiconductor device and the design data including the manufacturing condition are also connected to the network.

The design data is expressed in, for example, a GDS format or an OASIS format and is stored in a predetermined style. The type of the design data can be any type as long as software for displaying the design data can display the format style and as long as the design data can be handled as figure data. The storage medium 2405 may include a control apparatus of a measuring apparatus or an inspecting apparatus, the condition setting apparatus 2403, or the simulator 2404.

Each of the CD-SEM 2401 and the defect inspecting apparatus 2402 includes a control apparatus, and control necessary for the apparatuses is performed. The control apparatuses may include a function of the simulator or a setting function of a measurement condition and the like.

In the SEM, a plurality of stages of lenses focus an electron beam released by an electron source, and a scanning deflector applies focused electron beam to a sample to one-dimensionally or two-dimensionally scan the sample.

A detector detects a secondary electron (SE) or a backscattered electron (BSE) released by the sample as a result of the scan by the electron beam, and the electron is stored in a storage medium, such as a frame memory, in synchronization with the scan by the scanning deflector. A computing apparatus included in the control apparatus integrates image signals stored in the frame memory. The scan by the scanning deflector is possible in arbitrary size, position, and direction.

The control apparatus of each SEM performs the control and the like, and images and signals obtained as a result of the scan by the electron beam are transmitted to the condition setting apparatus 2403 through a communication line network. Although the control apparatus that controls the SEM and the condition setting apparatus 2403 are separate in the description of the present example, the arrangement is not limited to this. The condition setting apparatus 2403 may collectively perform the control of the apparatus and the measuring process, or each control apparatus may perform the control of the SEM and the measuring process.

A program for executing the measuring process is stored in the condition setting apparatus 2403 or the control apparatus, and the measurement or computation is performed according to the program.

The condition setting apparatus 2403 has a function of creating, based on the design data of the semiconductor, a program (recipe) for controlling operation of the SEM, and the condition setting apparatus 2403 functions as a recipe setting section. Specifically, the condition setting apparatus 2403 creates a program for setting positions and the like for executing a process necessary for the SEM, such as desired measurement points on design data, contour line data of pattern, and simulated design data, as well as auto focus, auto stigma, and addressing points, to automatically control a sample stage, a deflector, and the like of the SEM based on the setting. A program for causing a processor, which extracts information of a region that serves as a template from the design data to create a template described later based on the extracted information, or a general-purpose processor to create a template is embedded or stored.

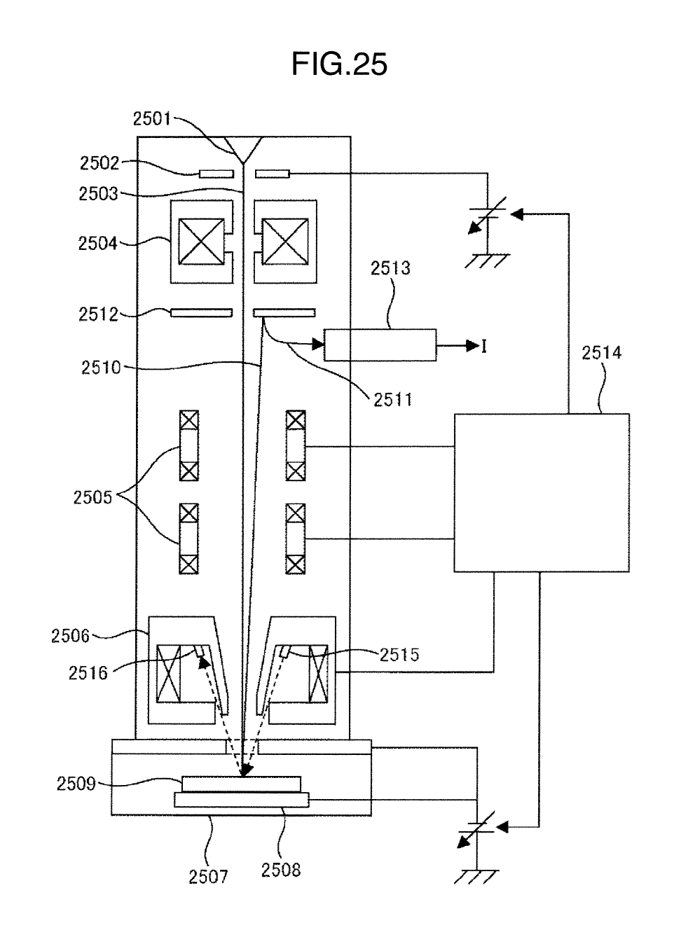

FIG. 25 is a schematic configuration diagram of a scanning electron microscope. A condenser lens 2504 as a mode of a focusing lens concentrates an electron beam 2503 extracted from an electron source 2501 by an extraction electrode 2502 and accelerated by an acceleration electrode not shown, and scanning deflectors 2505 apply the electron beam 2503 to a sample 2509 to one-dimensionally or two-dimensionally scan the sample 2509. The electron beam 2503 is decelerated by a negative voltage applied to an electrode embedded in a sample stage 2508. The electron beam 2503 is focused by lens effect of an objective lens 2506 and applied to the sample 2509.

When the electron beam 2503 is directed to the sample 2509, an electron 2510, such as a secondary electron and a backscattered electron, is released from the directed part. The released electron 2510 is accelerated in an electron source direction by acceleration effect based on the negative voltage applied to the sample. The electron 2510 collides against a conversion electrode 2512, and a secondary electron 2511 is generated. A detector 2513 captures the secondary electron 2511 released from the conversion electrode 2512, and output I of the detector 2513 changes according to the amount of the captured secondary electron. The brightness of a display apparatus not shown changes according to the output I. For example, to form a two-dimensional image, a deflection signal to the scanning deflectors 2505 and the output I of the detector 2513 are synchronized to form an image of the scanning region. The scanning electron microscope illustrated in FIG. 25 includes a deflector (not shown) that moves the scanning region of the electron beam.

Although the conversion electrode converts the electron released from the sample once and detects it in the example described in FIG. 25, it is obvious that the configuration is not limited to this. For example, an electron multiplier or a detection surface of a detector can be arranged on the orbit of the accelerated electron. A control apparatus 2514 controls each component of the scanning electron microscope and has a function of forming an image based on the detected electron and a function of measuring a pattern width of the pattern formed on the sample based on an intensity distribution of the detected electron called a line profile.

An optical microscope is further mounted on the scanning electron microscope illustrated in FIG. 25. The optical microscope mainly includes a light source 2515 and a light receiving section 2516, and the control apparatus 2514 coverts light received by the light receiving section 2516 to an image to form an optical image. The optical microscope has a pattern matching function of performing template matching on the obtained optical image based on images registered in advance to identify a position to be measured.

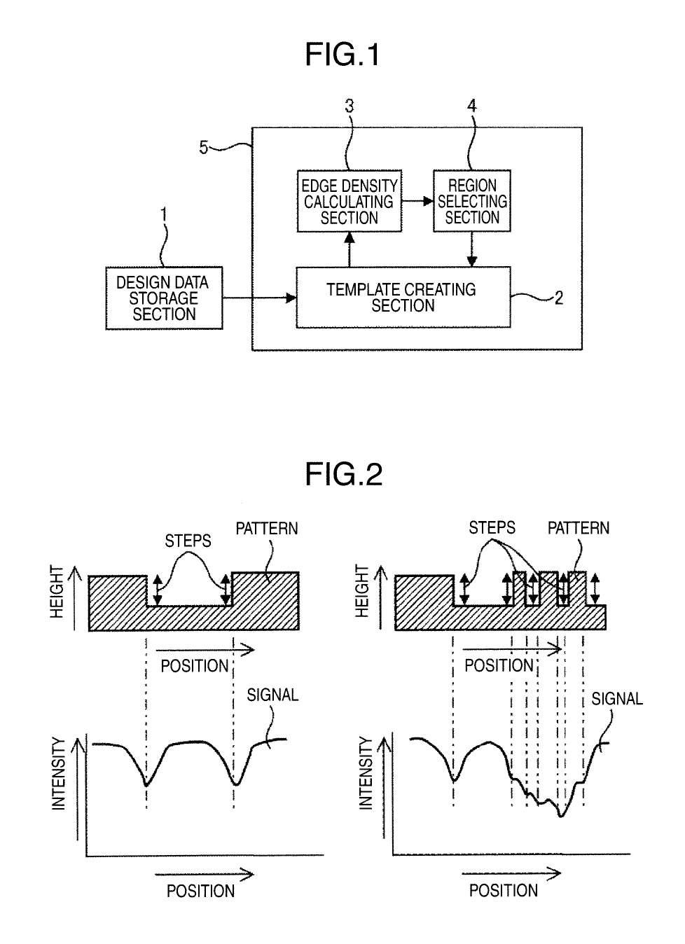

A mode of an image processing apparatus for performing image recognition will be described. The image processing apparatus can be included in the control apparatus 2514, or an embedded computing apparatus can execute image processing. An external computing apparatus (for example, condition setting apparatus 2403) can also execute image processing through a network. FIG. 1 is a diagram for explaining an example of an image processing apparatus that creates a template based on design data.

Design data (layout data) corresponding to a pattern of an OM image as a target of image recognition (matching) is stored in a design data storage section 1. A template creating section 2 of an image processing apparatus 5 creates a template image based on the design data corresponding to the pattern of the OM image of the design data storage section 1. In doing so, region information selected by a region selecting section 4 is also used. The design data may be read from the external storage medium 2405.

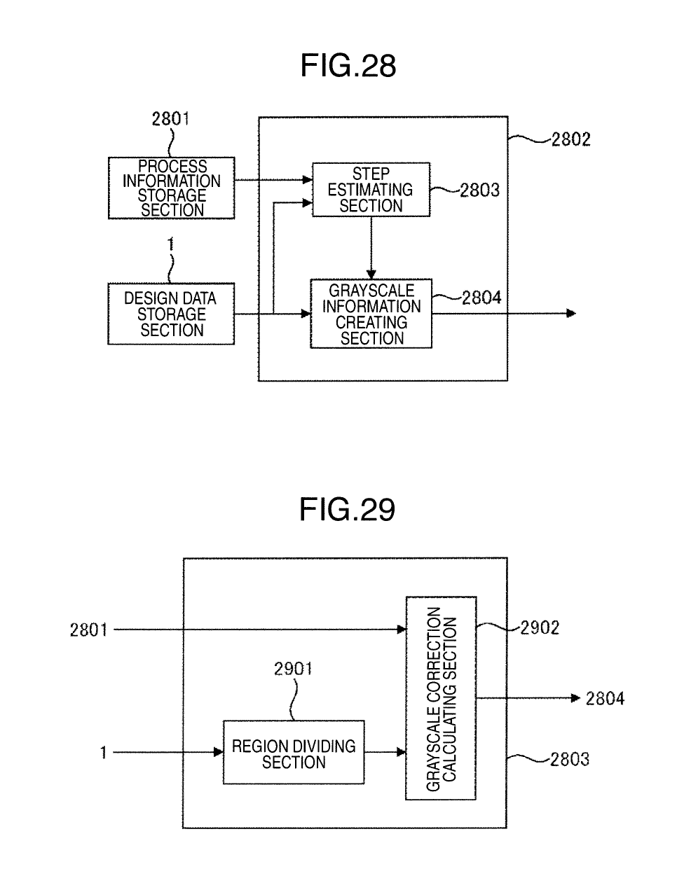

As illustrated in FIG. 28, a process information storage section 2801 that stores, separately from the layout data, information related to a semiconductor manufacturing process may be included. Information related to a planarizing process, such as CMP, of a wafer acquired in the OM image as a target of matching is stored in the process information storage section 2801. A step estimating section 2803 of a template creating section 2802 (image processing apparatus) estimates a step state of each pattern based on the process information of the process information storage section 2801 and the design data (layout data), and a correction value for correcting grayscale information is obtained. A grayscale information creating section 2804 creates a template image based on the correction value obtained by the step estimating section 2803 and the design data corresponding to the pattern of the OM image of the design data storage section 1. The design data may be read from the external storage medium 2405.

A sample is placed on a movable stage, and an optical microscope takes an OM image used in semiconductor inspection or the like. The OM image can be taken at a position corresponding to the design data. However, there is an error in the position movement of the stage, and the corresponding position is displaced to some extent. Therefore, an accurate corresponding position needs to be obtained in a matching process.

An edge density calculating section 3 obtains a density of pattern edges of a region corresponding to the pattern of the OM image based on the information obtained by drawing the design data by the template creating section 2. The region selecting section 4 selects a region that allows acquiring high-contrast sharp edges based on the information of the density of the pattern edges. The template creating section 2 creates a template image from a region suitable for the template selected by the region selecting section 4.

In the OM image, there is a known phenomenon in which a signal value of brightness (brightness value) decreases at a region of steps of a pattern as shown in FIG. 2. Therefore, the brightness is dark in a region with many steps of a pattern. Although depending on the reflectance of the pattern, the brightness value of a region without steps is relatively high, and the region is light if a light source close to broad is used. Therefore, a part with light brightness and a part with dark brightness can be figured out by observing the density of the steps of the pattern. It can be considered that the image has high contrast if a part with light brightness and a part with dark brightness both exist. The steps of the pattern can be considered as edges of the pattern. Therefore, the density of the pattern edges can be obtained to select a region including both a part with dense pattern edges and a part with sparse pattern edges. In this way, a region that always has high contrast and sharp edges can be set as a template, and the matching success rate improves in a matching process using the edge information or in a matching process using the contrast information.

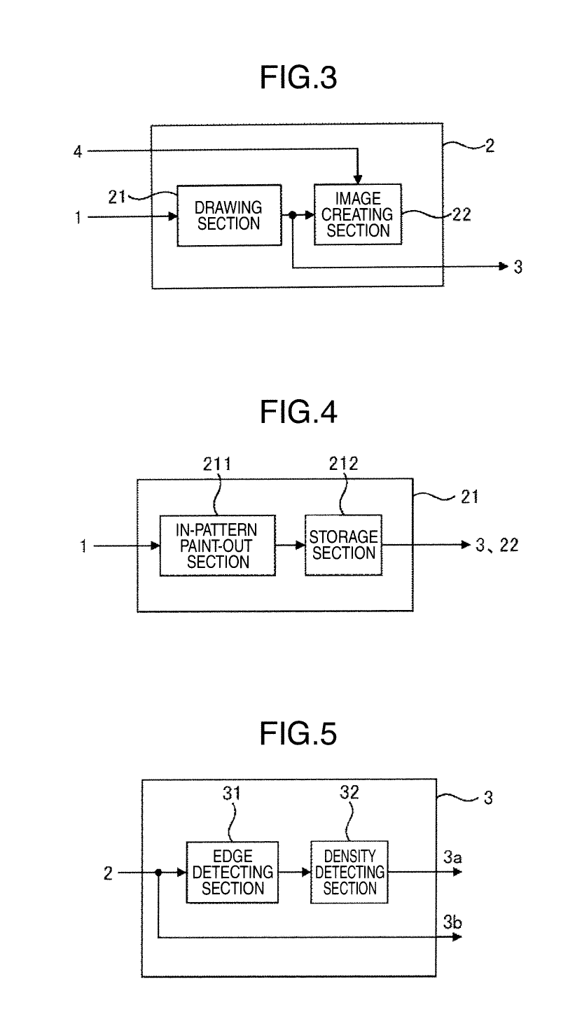

An embodiment of the template creating section 2 will be described with reference to FIG. 3. A drawing section 21 performs drawing based on the design data corresponding to the pattern of the OM image from the design data storage section 1. The design data is usually information such as vertex coordinates of the pattern, and the drawing section 21 converts the pattern corresponding to the pattern of the OM image to information of image data. An image creating section 22 uses the information of the template region selected from the drawn image data by the region selecting section 4 to create a template image.

FIG. 4 shows an embodiment of the drawing section 21. In the drawing based on the design data, an in-pattern paint-out section 211 can paint the inside and outside of a closed figure in different colors. The inside of the pattern is converted to white, and the outside of the pattern is converted to black to convert the pattern to image data. The image data is stored in the storage section 212.

There is a case of a pattern with a plurality of layers (multi-layer) in the drawing. In this case, each layer is similarly drawn based on the design data, and the data is stored in the storage section 212. The drawing section 21 can perform the drawing outside of the template creating section 2 or outside of the image processing apparatus 5. In this case, image data including the drawn design data can be stored in the design data storage section 1. The image creating section 22 of FIG. 2 will be described in detail later.

An embodiment of the edge density calculating section 3 will be described with reference to FIG. 5. An edge detecting section 31 detects edges in the image data drawn by the template creating section 2 based on the design data. The edge detecting section can be realized by a differential filter, such as a Laplacian filter and a Sobel filter. An image including drawn segments obtained from the vertex coordinates of the design data (image with only segments, in which the inside and the outside of the pattern are not painted in different colors) can be handled as output of the edge detecting section. A density detecting section 32 obtains the density of pattern edges. The density detecting section 32 can detect the density by obtaining a total value of values of the pattern edges included in specific regions around the target pixel. The density may be detected by obtaining the number of pixels in which the values of the pattern edges are greater than a specific value. Although the density is obtained for each pixel here, the density may be obtained for a plurality of pixels. The value of the obtained density can be interpolated to set the corresponding position finer than one pixel. The interpolation can be realized by a well-known technique, such as nearest, bilinear, and bicubic. The region selecting section 4 uses information 3a of the pattern edge density of the density detecting section 32. The region selecting section 4 also uses image data 3b in which the inside and the outside of the pattern are painted in different colors by the template creating section 2 used for the input of the edge density calculating section 3.

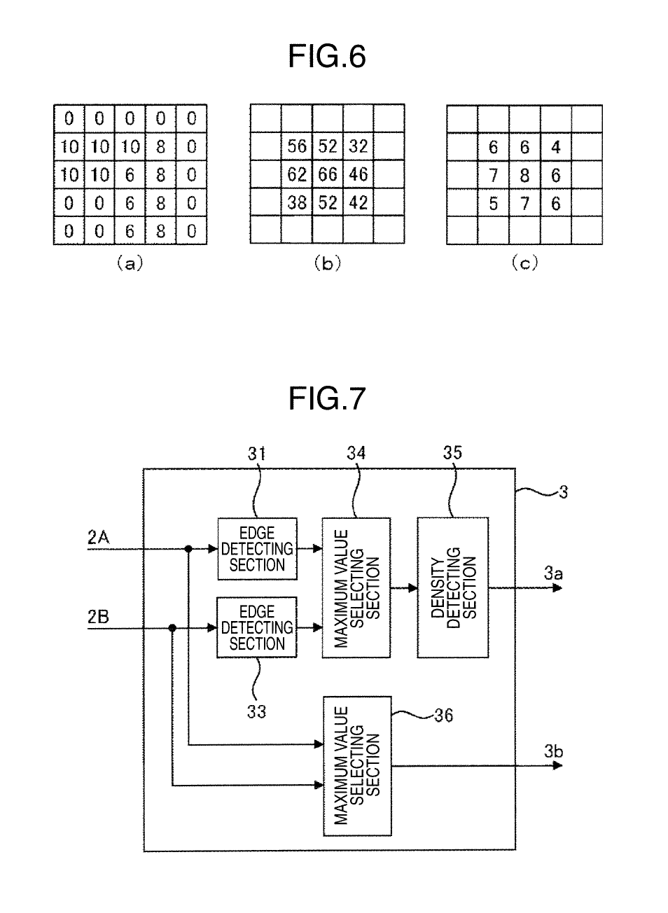

A specific example of the operation of the density detecting section 32 will be illustrated. For example, in a region of the edge detection result as shown in FIG. 6(a), the edge density of specific regions within one pixel adjacent to the target pixel (regions of 3 pixels by 3 pixels around the target pixel) is as shown in FIG. 6(b) when the total of the specific regions is obtained. The value may be the edge density. The edge density can be as shown in FIG. 6(c) when the edge density is the number of pixels in which the edge detection result of the specific region is 0 or more. The arrangement is not limited to this as long as information indicating the amount of edges in the specific range around the target pixel can be obtained.

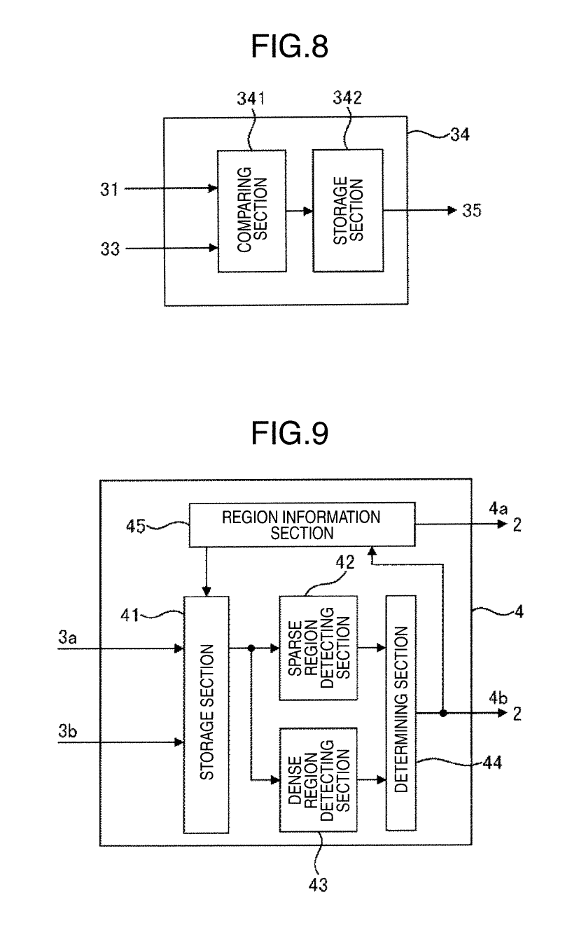

In the case of the multiple layers, a plurality of image data drawn by the drawing section 21 of the template creating section 2 are used for each layer. The edge density calculating section 3 of the present invention will be described with reference to FIG. 7. A case of using two layers will be described here. Edge detecting sections 31 and 33 detect edges in the image data of a 2A layer and a 2B layer, respectively. A maximum value selecting section 34 compares, pixel by pixel, the detected edge detection results and selects edges with greater values. The image data after the detection by the edge detecting sections 31 and 33 is large (white) if the edges are strong and is small (black) if the edges are weak. Therefore, if there are edges in one of the layers, the value of the edges is preferentially reflected. The density detecting section 35 obtains the density of the pattern edges based on the result of the selection of the maximum value (white one) of the edges of the layers selected by the maximum value selecting section 34. The maximum value selecting section 34 can be realized by a comparing section 341 and a storage section 342 as shown in FIG. 8. The values after the edge detection of the layers are compared to select the larger ones, and the values are stored in the storage section 342. The storage section 342 may not be included.

If there is the storage section 342, for example, 0 can be stored for everything in the storage section 342. It is possible to use only the edge detecting section 31 to sequentially perform the edge detection of the 2A layer and the 2B layer. The maximum value selecting section 34 can read the already stored, currently maximum value of the edges in the comparison. In the detection of the pattern edges, edges of a part with the lower pattern hidden by the pattern of the upper layer can be removed. In this case, whether the pattern is hidden can be determined from the design data. In this case, the drawing section 21 can remove the pattern section (white), which is covered by the upper layer and cannot be seen, in advance and can set the pattern section as the outside of the pattern (black).

The density detecting section 35 of FIG. 7 can be realized in the same way as the density detecting section 32 of FIG. 5. The maximum value selecting section 36 compares, pixel by pixel in the layers, the image data, in which the inside and outside of the pattern are painted in different colors by the template creating section 2, used for the input of the edge density calculating section 3 in FIG. 7. If there is a maximum value (white one), i.e. if there is a pattern in one of the layers, it becomes white and is handled as information indicating pattern presence/absence information. The inside of the maximum value selecting section 36 is similar to the maximum value selecting section 34. The region selecting section 4 uses the output 3b of the maximum value selecting section 36.

Although there are two layers for the density detecting section 32, the same can be applied even if there are more than two layers.

An embodiment of a region selecting section will be described with reference to FIG. 9. The density information 3a of edges obtained by the edge density calculating section 3 and the pattern presence/absence information 3b are stored in a storage section 41. The density information 3a of edges and the pattern presence/absence information 3b of the part corresponding to the designated template region are read from the storage section 41 based on information of the coordinate position (x, y) of the template region and the region size (horizontal and vertical size of the region) obtained from the region information section 45. More specifically, the part corresponding to the template region is cut out from the entire stored image region, and the density of the edges of the part corresponding to the template region is obtained. The user can designate in advance the information of the coordinate position and the region size of the template region of the region information section 45. The information of the coordinate position (x, y) and the region size (vertical and horizontal size of the region) can be designated in pixels or nm.

A sparse region detecting section 42 detects a region inside of the pattern, in which the density of pattern edges is low. For example, a region without any pattern edges throughout a specific range can be detected. A dense region detecting section 43 detects a region inside of the pattern, in which the density of pattern edges is high. For example, all regions other than the region without any pattern edges throughout a specific range can be regions in which the density of pattern edges is high. The determining section 44 determines whether the data is suitable for the template based on the amount of regions detected by the sparse region detecting section 42 in which the density of pattern edges is low and the amount of regions detected by the dense region detecting section 43 in which the density of pattern edges is high. For example, if the regions in which the density of pattern edges is low and regions in which the density of pattern edges is high are included at a specific ratio relative to the image regions, the determining section 44 can determine that the data is suitable for the template. Otherwise, the determining section 44 can determine that the data is not suitable for the template. The signal information 4a indicating whether the data is suitable for the template is transmitted to the template creating section 2 along with the coordinate position of the template region at that time and the information 4a of the region size.

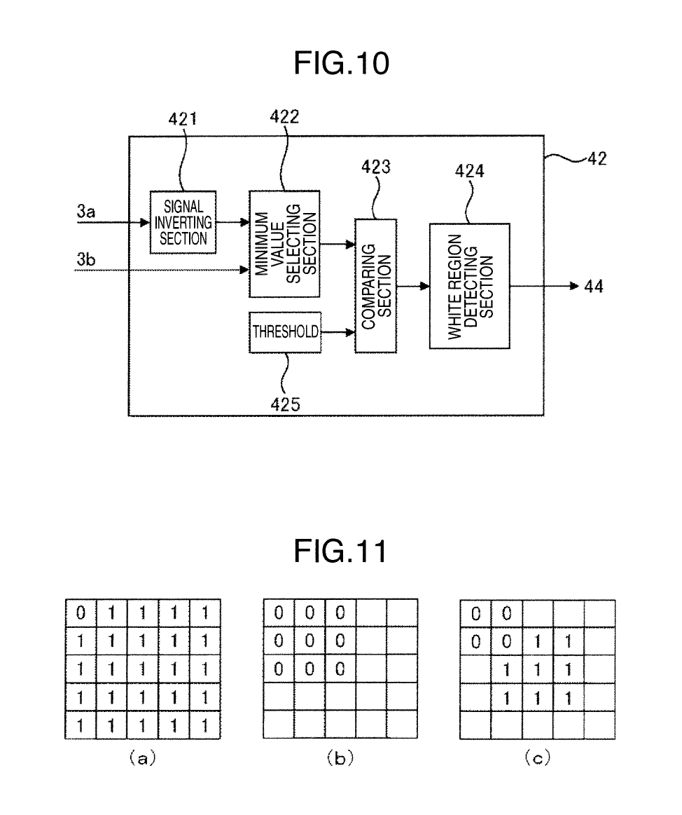

The storage section 41 of FIG. 9 can be realized by a memory. FIG. 10 shows an embodiment of the sparse region detecting section. A signal inverting section 421 inverts a signal value relative to the density information 3a of edges stored in the storage section 41. For example, if the maximum value of the density information 3a is 255 and the minimum value is 0, the result of the signal inverting section 421 indicates a value of the maximum value—the density information 3a. Specifically, if the density information 3a indicates 0, the value after the inversion is 255. If the density information 3a indicates 255, the value after the inversion is 0. A minimum value selecting section 422 compares the signal after the inversion with the pattern presence/absence information 3b stored in the storage section 41 to replace each pixel by a smaller value. When the edge density information of the pattern is inverted, the pattern becomes blacker with an increase in the edge density. Since the regions inside of the pattern are white, if the minimum value selecting section 422 selects smaller (blacker) ones, only regions with low edge density remain white inside of the pattern. The comparing section 423 compares the regions with a threshold 425 with a specific value. Regions smaller than the threshold are set to black, and regions greater than the threshold are set to white to binarize the regions. A white region detecting section 424 detects a part that remains white across a range greater than a certain regional range.

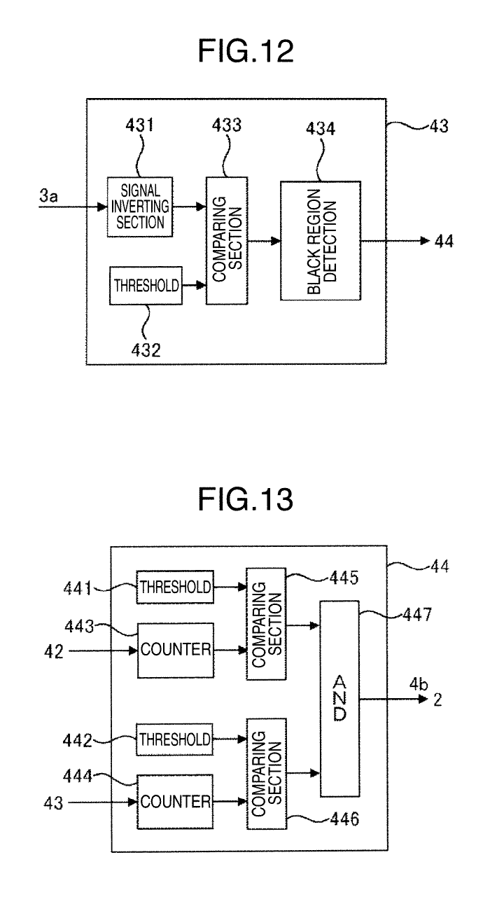

For example, there are white (1) and black (0) in a pixel region of 5 pixels by 5 pixels as shown in FIG. 11(a), and the certain regional range is a region within two pixels from the target pixel (region of 5 pixels by 5 pixels around the target pixel). Since the upper left pixel is black (0) as shown in FIG. 11(b), the regions within two pixels from the pixel are not set to white regions, but are set to non-white regions (0). If the certain regional range is a region within one pixel from the target pixel in FIG. 11(a) (region of 3 pixels by 3 pixels around the target pixel), since there is no black (0) in the region of 3 pixels by 3 pixels around the center, the regions around the center are determined as white regions (1) as shown in FIG. 11(c). The pixels determined to be the white regions are handled as sparse region pixels. FIG. 12 shows an embodiment of the dense region detecting section. A signal inverting section 431 inverts the signal value relative to the density information 3a of edges stored in the storage section 41. This is the same as the sparse region detecting section 42. A comparing section 433 compares the regions with a threshold 432 with a specific value. Regions smaller than the threshold are set to black, and regions greater than the threshold are set to white to binarize the regions. A black region detecting section 434 detects a part that remains black across a range greater than a certain regional range. The black region detecting section 434 can be realized in the same way as the white region detecting section 424, since the only difference is that the target of detection is white or black. The pixels determined to be black regions are handled as dense region pixels.

FIG. 13 shows an embodiment of the determining section. Counters 443 and 444 are used to count the number of sparse region pixels and the number of dense region pixels obtained by the sparse region detecting section 42 and the dense region detecting section 43. If the counted number is greater, it can be determined that there are a large number of sparse regions or dense regions.

Comparing sections 445 and 446 compare the counted values with thresholds 441 and 442, respectively. If these two comparison results are greater than the thresholds (output of comparing section is “1”), i.e. if the numbers of both the sparse regions and the dense regions are greater than the numbers of certain specific regions, the result of AND 447 is “1”, and it is determined that the data is suitable for the template. If one of the counted values is smaller than the threshold (output of comparing section is “0”) in the comparison with the thresholds 441 and 442, the result of the AND 447 is “0”, and it is determined that the information is not suitable for the template.

As for the region information section 45 in FIG. 9, even if the user does not set data, it is convenient if the determination of whether the data is suitable for the template is used to automatically obtain information of the coordinate position and the region size of the template region. Even if the user first designates the data, the template can be created by acquiring information of the coordinate position and the region size of the region suitable for the template close to the position designated by the user based on the determination of whether the data is suitable for the template.

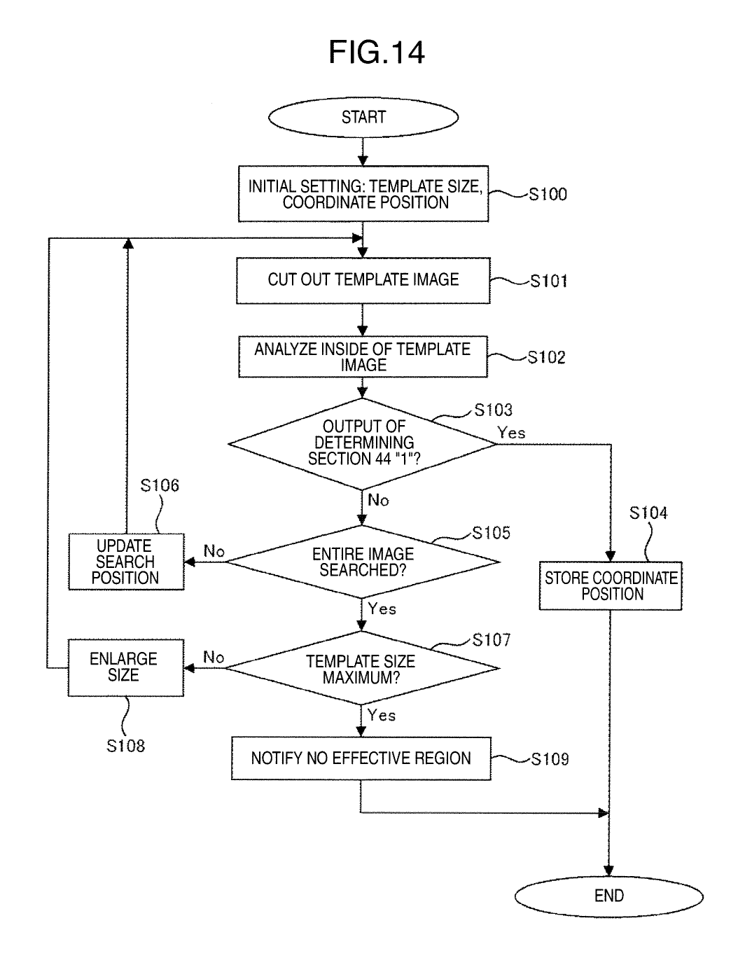

FIG. 14 shows a detection flow of the coordinate position and the region size of the template region. In S100, initial setting of the template size and the coordinate position is performed. For example, the smallest value can be the initial value of the template size. As for the coordinate position, (0, 0) can be initial coordinates if the upper left corner (x, y) of the image as a target of the template is (0, 0). In S101, the image data (the density information 3a of edges and the pattern presence/absence information 3b) of the template size is cut out from the position corresponding to the coordinate position of the template of the storage section 41. In S102, the ratio and the like of the dense and sparse pattern edges are obtained from the cut image data (the density information 3a of edges and the pattern presence/absence information 3b) of the template to determine whether the data is suitable for the template. In S103, if the determination result of the determining section 44 is “1” and the data is suitable for the template, the coordinate value is stored and transmitted to the template creating section 2. If the determination result is “0” and the data is not suitable, whether S101 to S103 are carried out at all coordinate positions of the template is determined in S105. If S101 to S103 are not carried out for all coordinate positions, the coordinate position is updated in S106 to the coordinate position without the implementation of S101 to S103 to carry out S101 to S103. If S101 to S103 are carried out at all coordinate positions, whether there is a template size without the implementation of S101 to S103 is determined in S107.

For the initial value, the template size is set to the smallest value here. In this case, whether the template size is the maximum is determined. If the template size is not the maximum, the size is increased in S108, and S101 to S103 are carried out. If the template size is the maximum in S107, for example, information indicative of no effective region shown in S109 can be transmitted to the template creating section 2 or the user in a visible format.

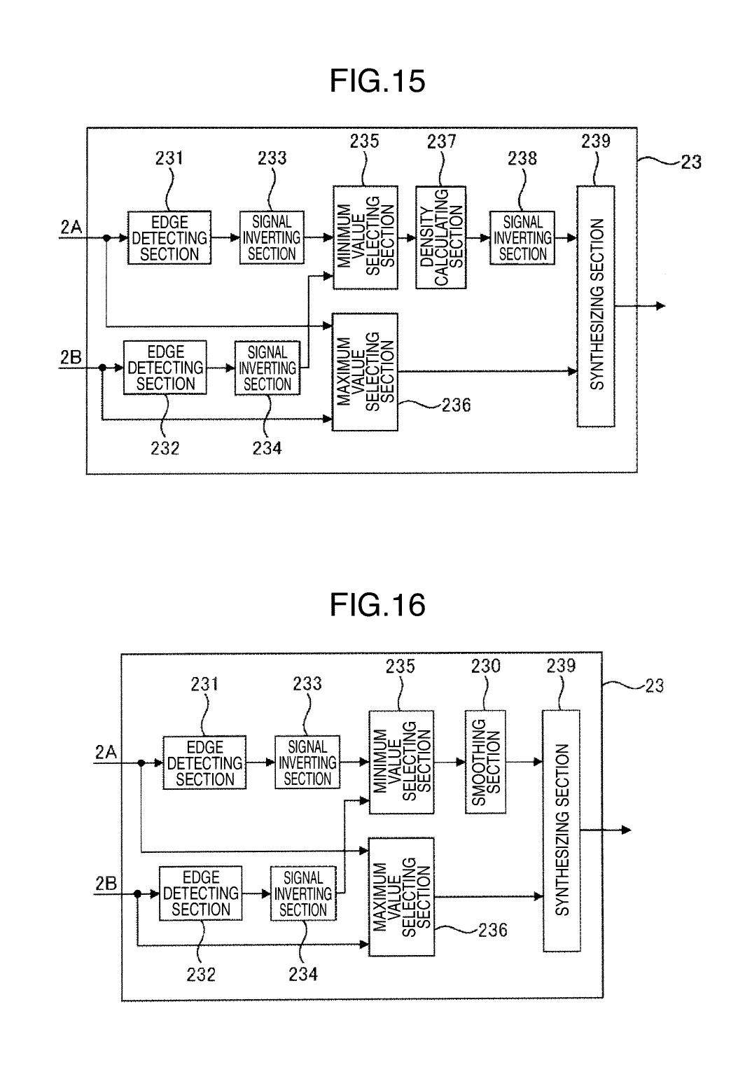

The image creating section 22 of the template creating section 2 will be described with reference to FIG. 15. A case of two layers including the 2A layer and the 2B layer will be described. An edge detecting section 231 and an edge detecting section 232 detect edges for the 2A layer and the 2B layer. A signal inverting section 233 and a signal inverting section 234 invert the signals. A minimum value selecting section 235 selects the minimum value of each pixel. Since the pattern edge part is black, the pixel remains black if one of the layers has pattern edges. The edges of the part where the lower pattern is hidden by the pattern on the upper layer can be removed in the detection of the pattern edges. In that case, whether the pattern is hidden can be obtained from the design data.

As for the 2A layer and the 2B layer, a maximum value selecting section 236 selects the maximum value in each pixel. Since the inside of the pattern is painted out in white, the pixel remains white if one of the layers is inside of the pattern. The brightness of the region with the steps of the pattern is reduced. The region becomes blacker with an increase in the steps. Therefore, a density calculating section 237 can calculate the density of the pattern, and the brightness value can be estimated based on the density information.

It is considered here that the region becomes blacker in proportion to the height of the pattern density. Instead of the simple proportion, a formula calculated from empirically obtained information may be used, or values based on the empirically obtained information may be used to form a table. The density calculating section 237 can be realized in the same way as the density detecting section 32 described in FIG. 5. A signal inverting section 238 inverts the information of the density obtained by the density calculating section 237 to blacken the region in proportion to the height of the pattern density. A synthesizing section 239 synthesizes the values. In the synthesis, the values can be blended at a specific ratio.

A smoothing section 230 can apply a smoothing process to the image with the pattern edges remained black by the minimum value selecting section 235 as shown in FIG. 16. In this way, the density of the pattern edges can be obtained, and the synthesizing section 239 can synthesize the images. The smoothing section can be realized by a general smoothing filter. For example, the density can be obtained by executing a process of adding information of surrounding pattern edges using a smoothing filter with uniform weight, a Gaussian filter, or the like. The order of the smoothing section 230 can be switched with the synthesizing section 239, and the smoothing section 230 can smooth the synthesized image.

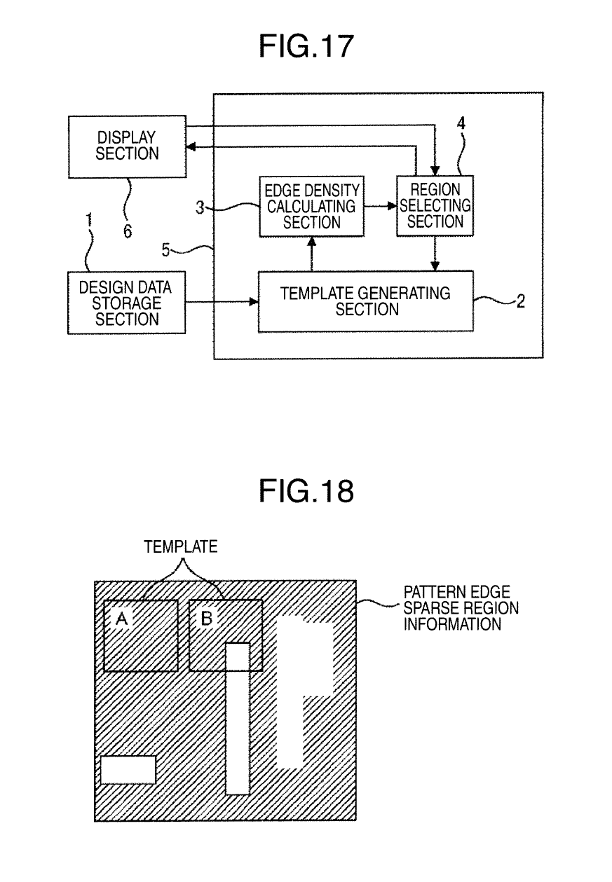

Other than the method of using the density information of pattern edges to automatically set the data, the user can set the data while viewing the density information of pattern edges. In this case, a display section 6 can be arranged as shown in FIG. 17, and the display section 6 can display the image of the information obtained by the sparse region detecting section 42 and the dense region detecting section 43 of the region selecting section 4. Furthermore, as shown for example in FIG. 18, a binary signal as output of the sparse region detecting section 42 can be used. The region with sparse density of edges can be displayed in white, and the region other than the sparse region (non-sparse region) can be displayed in black.

When the user sets a template, if it is recognized in advance that a region including both the sparse region (white) and the non-sparse region (black) of edges is suitable for the template, the user can determine that a region A is not suitable for the template when the user selects the region A, because there is no sparse region (white) of edges. When the user selects B, the user can determine that B is suitable for the template, because B is a region including both the sparse region (white) and the non-sparse region (black) of edges. The coordinate position of the template and the template size set by the user can be set to the region information section 45 of the region selecting section 4. The information can be transmitted to the template region to create a template with the region selected by the user.

The display section 6 can display an instruction for switching a mode of automatically setting the template, a mode of manually setting the template, and the like as described above and can display information indicating whether the current mode is automatic or manual.

Although the image creating section 22 of the template creating section 2 creates a multi-valued template, the created multi-valued template can be compared with something specific to binarize the template to create a binary template.

The image creating section 22 of the template creating section 2 can use a binary signal as output of the sparse region detecting section 42 shown in FIG. 18 to form a template. A binary signal as output of the dense region detecting section 43 can also be used to form a template.

All of the multi-valued template, the template obtained by binarizing the multi-valued template, the binary template as output of the sparse region detecting section 42, and the binary template as output of the dense region detecting section 43 can also be created.

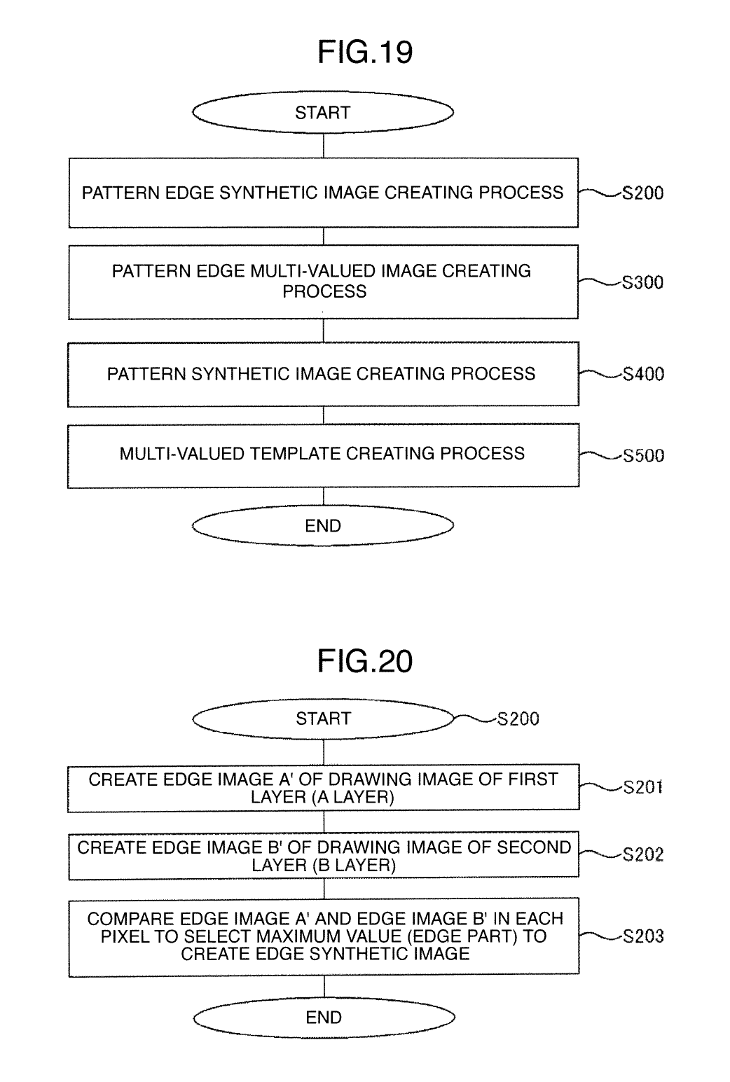

FIG. 19 shows a summary of a processing flow of the image creating section. In a pattern edge synthetic image creating process S200, a pattern edge image is created from a drawing image (pattern image) of each layer, and the pattern edge images of the layers are synthesized to create a pattern edge synthetic image. In a pattern edge multi-valued image creating process S300, the density of pattern edges is obtained from the pattern edge synthetic image, brightness reduction of the pattern is estimated from the density of pattern edges, a brightness value of each pixel is obtained, and a pattern edge multi-valued image is created.

In a pattern synthetic image creating process S400, the drawing images (pattern images) of the layers are synthesized to create a pattern synthetic image. In a multi-valued template creating process S500, the pattern edge multi-valued image and the pattern synthetic image are synthesized.

FIG. 20 shows a processing flow of a pattern edge synthetic image creating process. A pattern of two layers will be used in the description here. In S201, edge detection is applied to the drawing image of the first layer (A layer) to create an edge image N. In S301, an edge image B′ is similarly created for the drawing image of the second layer (B layer). The image is white if the edges are large, and the image is black if the edges are small. In S203, the edge image N and the edge image B′ are compared pixel by pixel, and maximum values (values of larger edge parts or edges) are selected to create an edge synthetic image. Since the edges are left if there are edges in one of the layers, the edge synthetic image is an image with edges placed on top of each other.

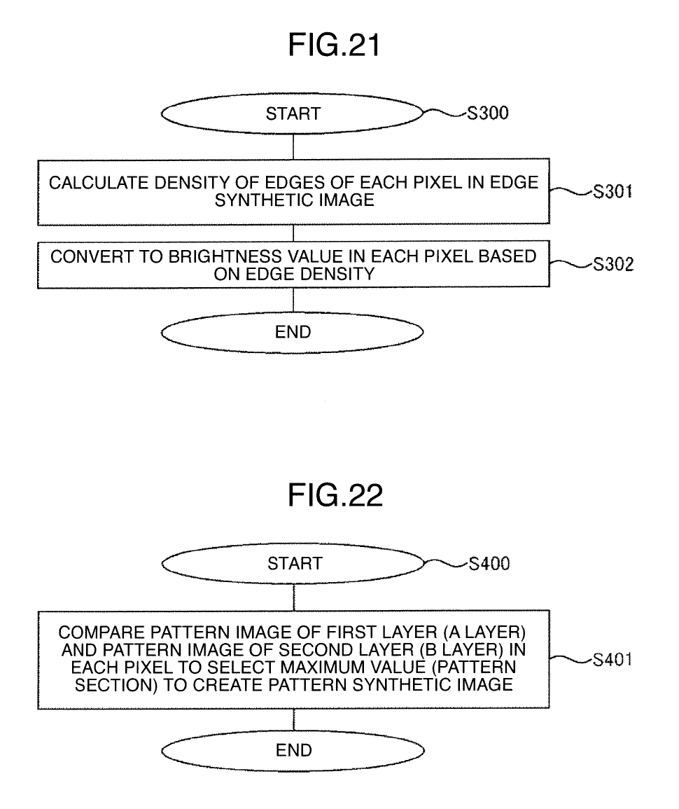

FIG. 21 shows a processing flow of a pattern edge multi-valued image creating process. In S301, the density of edges is calculated for the pattern edge synthetic image created in the pattern edge synthetic image creating process. In this case, the density of pattern edges of each pixel is obtained from the number or amount of pattern edges around the pixel. In S302, the pixel is converted to a brightness value based on the edge density of each pixel. For example, if the decrease in the brightness value due to the steps of the pattern is inversely proportionate to the height of the density of the pattern, a value obtained by inverting the value of the density of the pattern can be set as the brightness value. More specifically, when the maximum value of the signal of the edge density and the brightness value is 255 and the minimum value is 0, the bright value is 255 if the edge density is 0, and the bright value is 0 if the edge density is 255. In the conversion to the brightness value, a formula calculated from empirically obtained information may be used instead of the simple proportion, or values based on empirically obtained information can be included in a table.

FIG. 22 shows a processing flow of a pattern synthetic image creating process. The drawing image (pattern image) of the first layer (A layer) and the drawing image (pattern image) of the second layer (B layer) are compared pixel by pixel, and the maximum values (pattern sections) are selected to create a pattern synthetic image. In the drawing image (pattern image), the pattern section (inside of the pattern) is drawn in white (255), and the non-pattern section (outside of the pattern) is drawn in black (0). Therefore, if there is a pattern section (white) in one of the layers, the white of the pattern section is prioritized, and a remaining image is obtained.

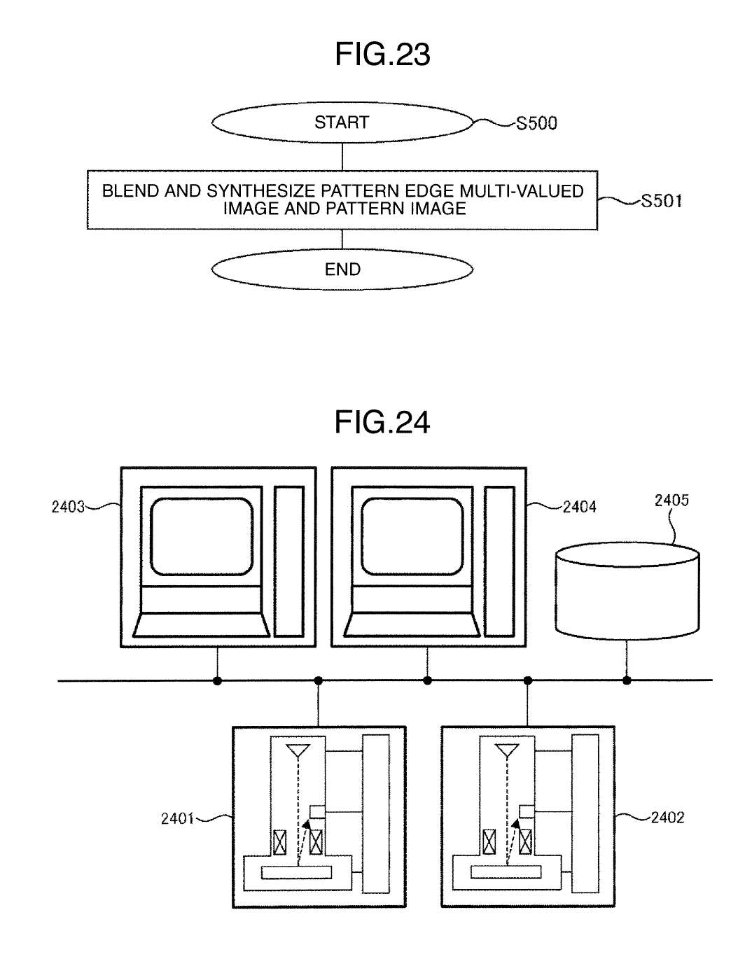

FIG. 23 shows a processing flow of a multi-valued template creating process. The pattern edge multi-valued image obtained in the pattern edge multi-valued image creating process and the pattern synthetic image obtained in the pattern synthetic image creating process are synthesized here. In the synthesis, the pattern edge multi-valued image and the pattern synthetic image creating process can be added and synthesized at specific ratios.

To obtain the synthetic image of pattern edges in the case of the multiple layers, edges of a part where the lower pattern is hidden by the pattern on the upper layer can be removed. In this case, whether the pattern is hidden can be obtained from the design data.

The process of the image processing apparatus of the present invention may be executed in a software process. In doing so, a personal computer may execute the software process, or the process may be incorporated into an LSI to execute a hardware process.

The pattern density determination method (edge density determination method) can be applied to a recipe verifying method for verifying a created recipe, an assist function for assisting the operator in creating the template, and an automatic template creating method. Hereinafter, a specific application method of the pattern density determination method will be described.

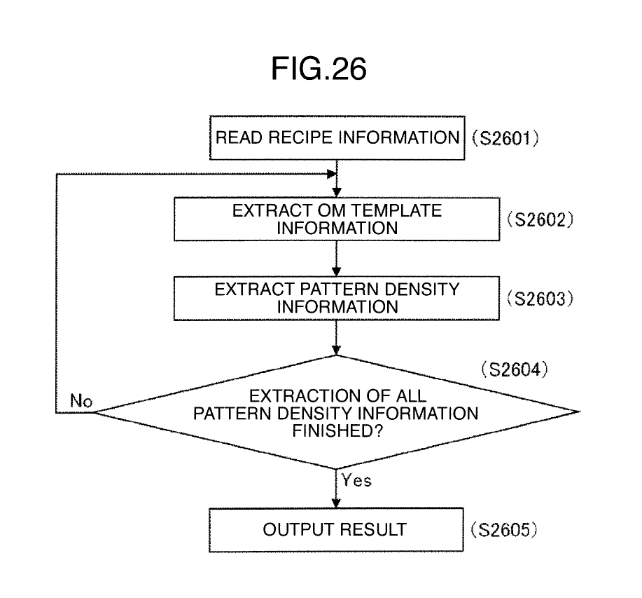

FIG. 26 is a flow chart showing a verifying process of a recipe. As described, the recipe denotes an operation program for automatically operating the scanning electron microscope and the like, and template information for OM matching is recorded in part of the recipe. If the template information is not appropriate, an error may occur during the automatic control of the SEM. Therefore, if the suitability of the recipe can be verified in advance, the error rate can be suppressed in the actual operation of the recipe. First, recipe information to be verified is read (step 2601), and information of an OM template is extracted from the recipe information (step 2602). The density information of the pattern is extracted from the OM template information (information of the region selected as the template) according to the method described above (step 2603). As described with reference to FIG. 2, if the part with high brightness (part with sparse edges) and the part with low brightness (part with dense edges) are properly mixed, the image can be defined as an image with high contrast. Therefore, if, for example, the ratio of the light part and the dark part is at an arbitrary ratio (for example, 1:1) or within a ratio range around the arbitrary ratio, the template can be determined to be appropriate. If the ratio of the light part and the dark part is not at the set arbitrary ratio or within the ratio range, the template is determined to be an inappropriate template or a template that needs to be revised. The result is output on the display apparatus (step 2605). If there are regions to be searched based on a plurality of OM templates on the semiconductor wafer, steps 2602 and 2603 are repeated to extract the density information of the OM template again (step 2604).

According to the configuration, the suitability of the recipe can be verified without the actual operation of the apparatus.

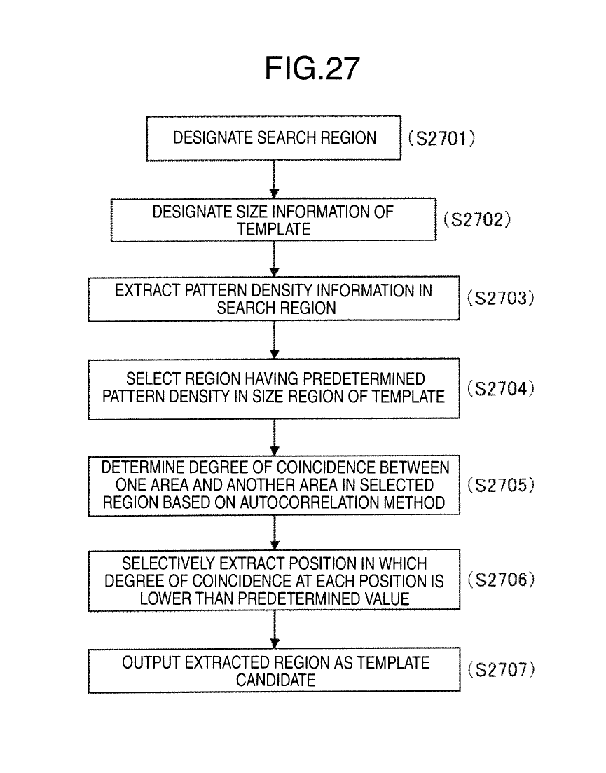

An assist function for assisting the operator in the creation of the template and an automatic template creating method will be described with reference to a flow chart of FIG. 27. First, a search region for template matching is designated (step 2701). Size information of the template is then designated (step 2702). Although an example of arbitrarily designating the size of the template will be described in the present example, this process is not necessary if the size is determined in advance. Pattern density information in the search region is extracted (computed) (step 2703). A region having a predetermined pattern density condition is selected in a partial region in the size of the template (step 2704). For example, if a light region (part with sparse edge density) and a dark part (part with dense edge density) are properly mixed in the region in the same size as the template, the part is a region in which at least some contrast can be obtained. If another condition (for example, a unique shape is included) is satisfied, it can be stated that region can be suitably selected as a template. Therefore, a region distribution satisfying the condition can be displayed in the search region to allow the operator to visually determine the region to be selected as a template. More specifically, the result obtained in steps 2701 to 2704 can be displayed to assist the selection of the template region.

In step 2704, for the region selected as the region with predetermined contrast, the degree of coincidence with another region is determined for each region (hereinafter, “first region”) in the same size as the template (step 2705). Here, the degree of coincidence with another region (for example, region in the same size as the first region at a position displaced by one or more pixels from the first region) is obtained for the first region in the selected region based on an autocorrelation method or the like. The determination of the degree of coincidence in the entire selected region can determine whether the first region is a region to be selected as a template.

If the degree of coincidence between the first region and other regions (a plurality of other regions displaced by one or more pixels from the first region) is low, the first region is a region including a pattern or the like having a unique shape relative to the other regions, and it can be stated that the first region is a region to be selected as a template. On the other hand, if the degree of coincidence is high, another region that should not be identified in the matching may be identified as a matching position in the actual template matching, and it can be stated that the first region is a region prone to a matching error. Therefore, for example, a first region in which the degree of coincidence with the other regions is equal to or smaller than a predetermined value or a first region in which the degree of coincidence with the other regions is the lowest is extracted, and the extracted region is output as a template candidate (steps 2706 and 2707). In step 2706, the comparison is performed based on a result in which the degree of coincidence with the other regions is the highest among the results of the determination of the degree of coincidence between the first region and the plurality of other regions. A predetermined number of regions with the lowest degrees of coincidence may be extracted and output as template candidates.

According to the configuration, the region to be selected as a template can be narrowed down based on the contrast information not expressed in the design data and based on the AND condition of the information obtained from the design data. In the example, since the region subject to autocorrelation is narrowed down based on the density information of pattern edges, the configuration is also effective in reducing the processes.

The present example focuses primarily on the extraction of the region to be selected as a template based on the AND condition of the contrast information (pattern density information) not directly expressed in the design data and the information that can be directly extracted from the design data. Therefore, for example, a part having a predetermined pattern shape may be selectively extracted to obtain AND with the contrast information to narrow down the template candidates. The shape information (layout data) of the pattern is information that can be directly extracted from the design data. Therefore, if the template pattern suitable for the matching is empirically recognized, the template candidates may be narrowed down based on input of the information.

In the OM image, there is a phenomenon in which the signal value (brightness value) of brightness decreases as illustrated in FIG. 2 in the region including steps of the pattern as described above. Therefore, the brightness of the region with a large number of steps of the pattern is low. Although depending on the reflectance of the pattern, the brightness value of a region without steps is relatively high, and the region is light if a light source close to broad is used.

Since the semiconductor device nowadays has a multi-layer structure, there may be several tens of manufacturing processes. Along with the miniaturization, the manufacturing processes include a process of planarizing the wafer, such as reflow and CMP (polishing).

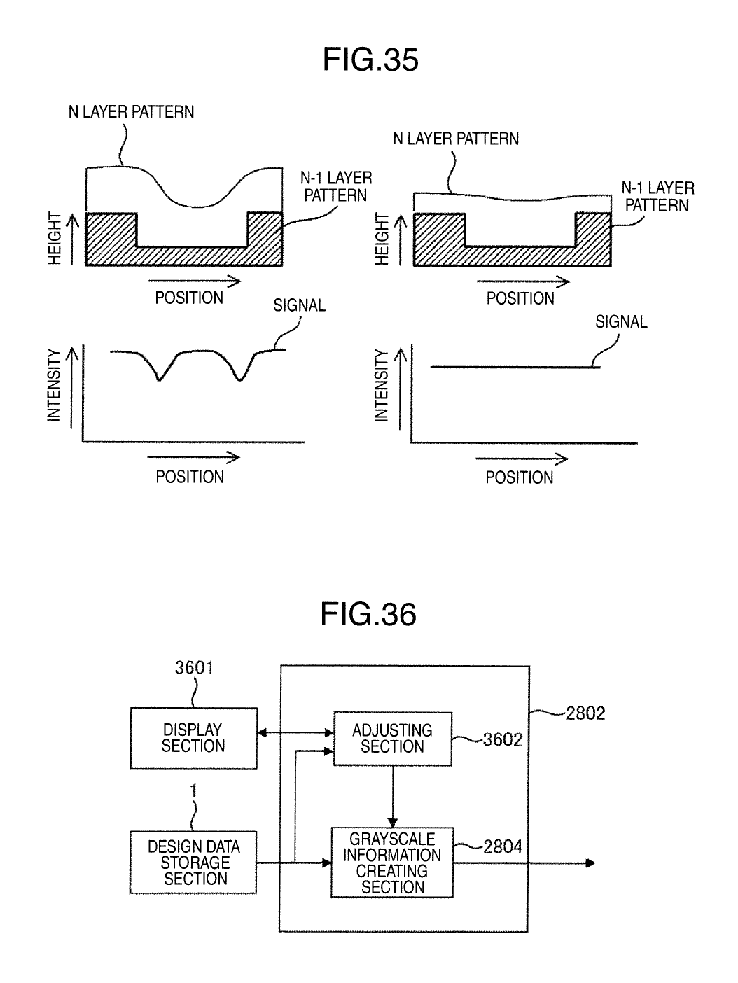

As illustrated in FIG. 35, if another layer uniformly overlaps over a pattern with steps, an upper layer (N layer) is affected by unevenness of a lower-layer (N−1 layer) pattern and becomes uneven, and the brightness decreases at a position corresponding to the unevenness. However, if, for example, a planarizing process, such as CMP (polishing), is applied to the upper layer (N layer), the unevenness of the upper layer (N layer) is eliminated, and the brightness is not reduced. After the creation of the lower-layer (N−1 layer) pattern, an interlayer insulating film can be placed to perform the planarization to absorb the unevenness of the lower-layer (N−1 layer). The upper layer (N layer) can then be placed, and in this way, the unevenness of the upper layer (N layer) can be prevented. Thus, the appearance of the OM image when the planarizing process is executed and the appearance of the OM image when the planarizing process is not executed are different. The size of the steps also varies depending on a process such as etching, and the appearance also varies. Therefore, process information, such as influence of the size of the pattern steps in each process, is used to estimate the pattern steps, and this is reflected on the gray values to create a template. An example of the process information includes information indicating whether the process is a planarizing process such as CMP (polishing).

When the appearance of the OM image varies depending on the manufacturing process, a template creating section 2802 that forms part of the image processing apparatus illustrated in FIG. 28 is used. FIG. 29 is a diagram for explaining a summary of a step estimating section 2803 included in the template creating section 2802 illustrated in FIG. 28. Based on the design data, a region dividing section 2901 at least divides the region into a region of pattern edges of the upper layer corresponding to the pattern of the OM image as a target of matching, a region of pattern edges of a layer below (lower layer), and a region of pattern edges of the lower layer that overlaps the pattern of the upper layer. The step state is estimated for each region based on the process information. A grayscale correction calculating section 2902 calculates a correction value used in the grayscale information creating section 2804.

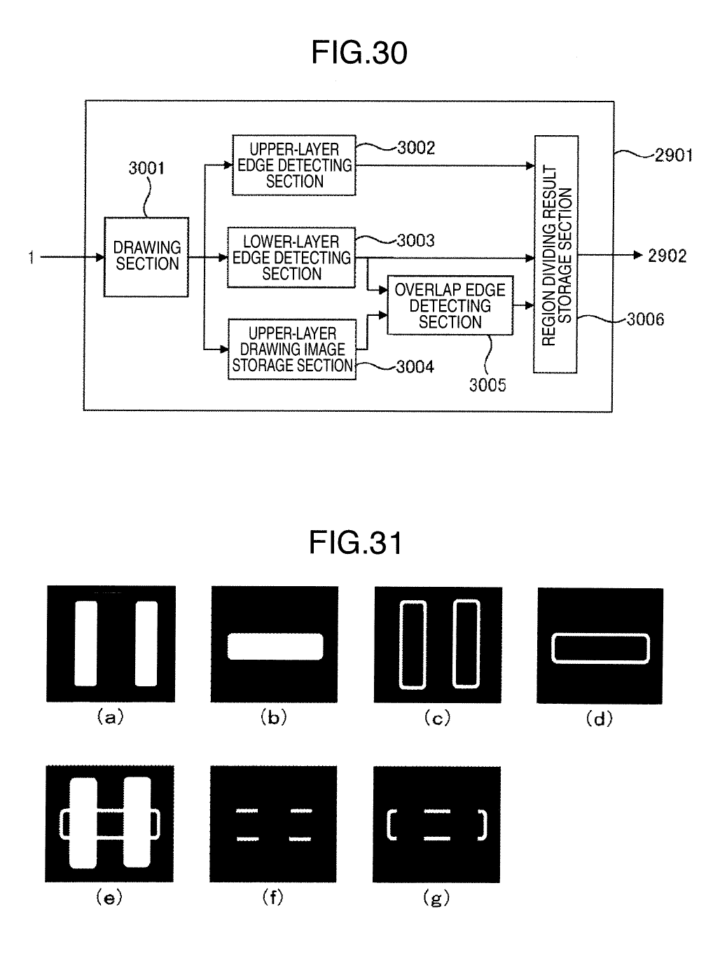

An embodiment of the region dividing section 2901 will be described with reference to FIG. 30. Based on the design data transmitted from the design data storage section 1, a drawing section 3001 draws a pattern of each layer, such as the upper layer (Nth layer) and the lower layer (N−1th layer) corresponding to the pattern acquired from the OM image as a target of matching. The design data is usually information of vertex coordinates of the pattern and the like. Therefore, the drawing section 3001 converts the pattern corresponding to the OM image to information of image data. In this case, the drawing section 3001 can be arranged outside of the region dividing section 2901 or outside of the step estimating section 2803 and the template creating section 2802 in advance to create the drawing image. Instead of the design data, the drawing image of each layer can be input to the region dividing section 2901 or to the step estimating section 2803 and the template creating section 2802. The pattern drawing image of the upper layer (Nth layer) is stored in an upper-layer drawing image storage section 3004. An upper-layer edge detecting section 3002 detects edges from the pattern drawing image of the upper layer (Nth layer) and stores the edges in a region dividing result storage section 3006. Similarly, a lower-layer edge detecting section 3003 detects edges from the pattern drawing images of the lower layer (N−1th layer) and stores the edges in the region dividing result 3006.

Based on the edge detection result of the lower-layer edge detecting section 3003 and the pattern drawing image of the upper layer (Nth layer) stored in the upper-layer drawing image storage section 3004, an overlap edge detecting section 3005 detects pattern edges of the lower layer that overlaps the upper-layer pattern and stores the pattern edges in the region dividing result storage section 3006.

Examples of the pattern drawing, the edge detection result, and the overlap edge detection result will be illustrated with reference to FIG. 31. FIG. 31(a) denotes the pattern drawing image of the upper layer, and (b) denotes the pattern drawing image of the lower layer. In this case, the edge detection result of the pattern drawing image of the upper layer is as shown in (c). The edge detection result of the pattern drawing image of the lower layer is as shown in (d). An image obtained by placing the pattern drawing image (a) of the upper layer and the edge detection result (d) of the pattern drawing image of the lower layer on top of each other is (e). The edge detection result with overlapped patterns is a region (f) in which (a) and (d) are both white.

The region division result storage section 3006 stores the edge region (c) of the upper layer, the edge region (f) of the lower layer overlapping the upper layer, and a region (g) obtained by deleting the edge region (f) overlapping the upper layer from the edge region (d) of the lower layer. The pattern drawing section 3001 included in the region dividing section 2901 illustrated in FIG. 30 has a configuration similar to the drawing section 21 illustrated in FIG. 4.

The upper-layer edge detecting section 3002 and the lower-layer edge detecting section 3003 can be realized by a differential filter, such as a Sobel filter and a Laplacian filter. For example, binarization (Otsu method or the like) may be performed after performing the differential filter. The edge part may be set to white “255”, and the non-edge part may be set to “0”. The upper-layer drawing image storage section 3004 can be realized by a memory. The overlap edge detecting section 3005 is realized by an AND circuit, and an AND result of the output of the lower-layer edge detecting section 3003 and the output of the upper-layer drawing image storage section 3004 is output. For example, AND of (d) and (a) of FIG. 31 is acquired, and an output result of (f) is obtained if white is output only when both are white.

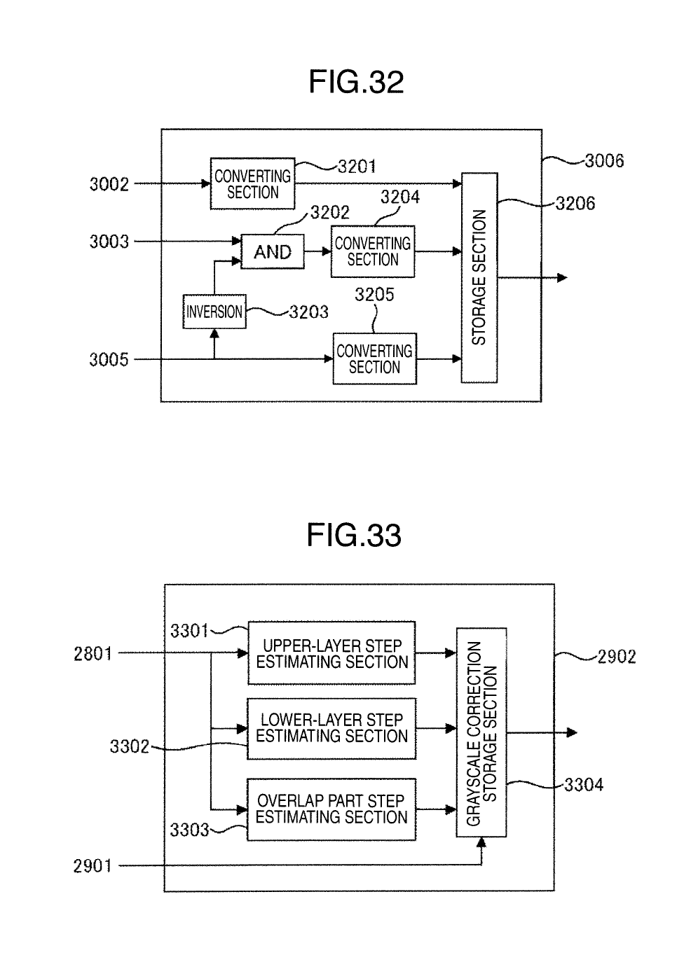

FIG. 32 shows an embodiment of the region division result storage section 3006. For the edge part (white “255”) and the non-edge part (black “0”) of the output of the upper-layer edge detecting section 3002, a converting section 3201 converts the edge part to “1” and the non-edge part to “0”, and the result is stored in the storage section 3206. For the output of the overlap edge detecting section 3005, a converting section 3205 converts the edge part to “3”, and only the edge part “3” is stored in the storage section 3206. An AND section 3202 uses output obtained by inversion of the output of the lower-layer edge detecting section 412 and the output of the overlap edge detecting section 3003 by an inverting section 3203 (due to the inversion, the edge part is black “0”, and the non-edge part is white “255”) to execute an AND process to set white “255” only when both are white “255”. A converting section 3204 converts the white part to “2”. The part is stored in the storage section 3206 only when the part is converted to “2”. More specifically, the edges of the upper layer (upper-layer edge part) are set to “1”, the edges of the lower layer not overlapping the pattern of the upper layer (lower-layer edge part) are set to “2”, the edges of the lower layer overlapping the pattern of the upper layer (overlap part) are set to “3”, and the other regions are set to “0”. Different values are allocated to pixel positions of the edges and stored.

FIG. 33 shows an embodiment of the grayscale correction calculating section 2902. Process information is input to an upper-layer step estimating section 3301, a lower-layer step estimating section 3302, and an overlap part step estimating section 3303. Information of the steps estimated from the step estimating sections 3301, 3302, and 3303 is input to a grayscale correction storage section 3304 in association with pixel positions of the upper-layer edge part, the lower-layer edge part, and the overlap part obtained by the region dividing section 2901. A conversion table can be used to realize the upper-layer step estimating section 3301, the lower-layer step estimating section 3302, and the overlap part step estimating section 3303. For example, information indicating whether the process is after the implementation of the planarization, such as CMP, is provided as the process information. The process information of the process after the planarization indicates “1”, and the process information indicates “0” otherwise. When the process information indicates “0”, for example, the steps of the patterns of the upper layer, the lower layer, and the overlap part remain. The upper-layer step estimating section 3301, the lower-layer step estimating section 3302, and the overlap part step estimating section 3303 output “100”. When the process information indicates “1”, for example, the steps of the patterns of the upper layer and the lower layer remain. The upper-layer step estimating section 3301 and the lower-layer step estimating section 3302 output “100”. The steps of the pattern of the overlap part are eliminated, and the overlap part step estimating section 3303 outputs “0”.

The output values are stored in the grayscale correction storage section 3304. The grayscale correction storage section 3304 can be realized by a memory. Correction values of the upper-layer step estimating section 3301, the lower-layer step estimating section 3302, and the overlap part step estimating section 3303 are stored as correction values corresponding to the pixel positions of the upper-layer edge part, the lower-layer edge part, and the overlap part obtained in the region dividing section 2901. Although the planarizing process is applied to the pattern of the upper layer in the case here, for example, an interlayer insulating film can be placed after the formation of the lower-layer pattern, and the upper-layer pattern can be placed after planarization of the interlayer insulating film in the planarizing process. In this case, the inside of the upper-layer pattern is also flat, and the pattern of the lower layer overlapping the upper-layer pattern cannot be seen. In doing so, the process information to be used needs to include not only information of the current process or the previous process in the semiconductor manufacturing as a target of matching, but also information of prior processes. For example, process information of prior planarizing processes can be tracked back, and a series of process information can be used.

After the planarizing process, the pattern that overlaps the lower layer when the pattern is placed can be ignored, and it can be considered that the pattern on the lower layer of an overlapping layer has an influence when a pattern is overlapped subsequently. When the pattern edges overlap at a position with the same pattern in the design data, steps of the patterns of two layers are piled up. The steps become larger, and the brightness can further decrease. In this case, the correction value can be enlarged twofold, etc. The information of the film thickness of the layers can be used to accurately obtain the size of the steps of the pattern. Other than the standpoint of the steps of the pattern, if the film thickness of the interlayer insulating film placed over the upper layer is thick, the contrast of the upper-layer and lower-layer patterns decreases. Therefore, the information of the film thickness of the layers can be used to correct the contrast. In this case, not only the step state, but also the appearance of the pattern can be estimated.

The interlayer insulating film is smooth depending on the material, and the flatness increases. Therefore, material information can be used to obtain the steps of the pattern. In this case, information of the film thickness of the layer can be included in the process information. A series of process names and details of the corresponding processes can be included in the process information. The step state of the pattern based on various processes, such as creation and etching of a resist pattern and photoresist removal, can be obtained, and the grayscale of each pixel can be obtained based on the step state to create the template. The user may be able to use a GUI or the like to simply set the process information related to the manufacturing process.

For the correction values of the upper-layer step estimating section 3301, the lower-layer step estimating section 3302, and the overlap part step estimating section 3303 corresponding to the process information, changes in the steps of the patterns of the regions (upper layer, lower layer, and overlap part) based on process names and process details can be checked in advance, and the correction values corresponding to the changes can be included in a table. The ratio of the synthesis of the grayscales of the pattern edges are determined based on the correction values. The correction values may be determined from the appearances of the OM images of the regions (upper layer, lower layer, and overlap part) based on the process names and the process details. A commercially available simulator can be used in advance to calculate and obtain changes in the steps of the patterns of the regions (upper layer, lower layer, and overlap part) based on the process names and the process details, and the changes can be included in the conversion table of the upper-layer step estimating section 3301, the lower-layer step estimating section 3302, and the overlap part step estimating section 3303. Formulas used in the simulator and the like can also be included to obtain the correction values by computation.

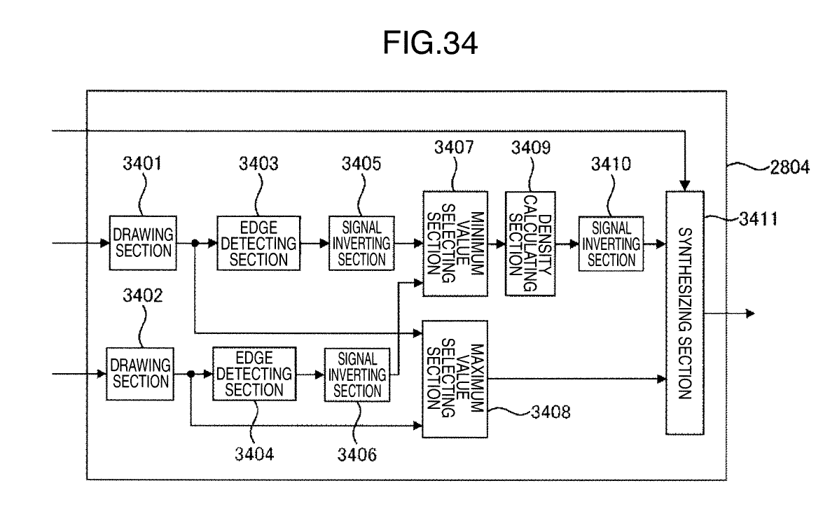

The grayscale information creating section 2804 will be described with reference to FIG. 34. A case of two layers including an upper layer and a lower layer will be described. Drawing sections 3401 and 3402 create pattern images for patterns of the upper layer and the lower layer of the design data. The drawing sections can have the same configuration as the configuration of the drawing section 21. An edge detecting section 3403 and an edge detecting section 3404 detect edges in the pattern images of the upper layer and the lower layer. A signal inverting section 3405 and a signal inverting section 3406 invert the signals. A minimum value selecting section 3407 selects a minimum value of the signals in each pixel. Since the edge part of the pattern is “0” (black), if one of the patterns includes pattern edges, the pattern remains “0” (black). The edge detecting sections 3403 and 3404 can be realized by differential filters just like the upper-layer edge detecting section 3002 and the lower-layer edge detecting section 3003. In the signal inverting sections, if the maximum value of input is 255 and the minimum value of input is 0, a value of the maximum value (255)—the input value is set. Specifically, the value after the inversion is 255 when the input is 0, and the value after the inversion is 0 when the input is 255.

The minimum value selecting section 3407 can be realized by the comparing section 341 and the storage section 342 as illustrated in FIG. 8. The values of the layers after the edge detection are compared to select the smaller one, and the value is stored in the storage section 342. The storage section 342 may not be included.

If the storage section 342 is included, for example, 0 can be stored for everything in the storage section 342. Edge detection can be sequentially performed not only for the upper layer and the lower layer, but also for the layers following below. The already stored current maximum value of the edges can be read in the comparison by the minimum value selecting section 3407. In the detection of the pattern edges, the edges of the part where the lower pattern is hidden by the pattern on the upper layer can be removed. In this case, whether the pattern is hidden can be obtained from the design data. In this case, the drawing sections 3401 and 3042 can exclude the pattern section (white), which overlaps the upper layer and cannot be seen, to set the section to the outside of the pattern (black). Meanwhile, a maximum value selecting section 3408 selects the maximum value of the patterns of the upper layer and the lower layer in each pixel. Since the inside of the pattern is painted out in “255” white, the pixel remains “255” white if one of the pixels is inside of the pattern.

The maximum value selecting section 3408 can be realized in the same way as the minimum value selecting section 3407. In this case, the difference is that the values after the edge detection of the layers are compared to select a larger one.

The brightness of the region with steps of the pattern decreases, and the brightness becomes closer to black with an increase in the steps. Therefore, a density calculating section 3409 can calculate the pattern density to estimate the brightness value based on the density information. It is considered here that the brightness becomes blacker in proportion to the height of the pattern density. Instead of the simple proportion, a formula calculated from empirically obtained information may be used, or values based on the empirically obtained information may be included in a table.

In the region of the result of the minimum value selecting section as shown in FIG. 6(a), the edge density of specific regions within one pixel adjacent to the target pixel (regions of 3 pixels by 3 pixels around the target pixel) is as shown in FIG. 6(b) when the total of the specific regions is obtained. The values may be the edge density. The edge density can be as shown in FIG. 6(c) when the number of pixels, in which the edge detection result of the specific region is 0 or more, serves as the edge density. The arrangement is not limited to this as long as information indicating the amount of edges in the specific range around the target pixel can be obtained.

A signal inverting section 3410 inverts the information of the density obtained by the density calculating section 3409 to make the pixels black in proportion to the height of the pattern density. A synthesizing section 3411 synthesizes the values. In the synthesis, the values can be synthesized at a specific ratio. The ratio of the synthesis is adjusted by the grayscale correction value from the step estimating section 2803. For example, when the grayscale correction value estimated to have steps is “100” (100%), if the ratio for synthesizing the gray values obtained from the pattern density is 60% of the original, the gray values are synthesized by the same 60% obtained by multiplying 60% by 1.0. When the grayscale correction value estimated not to have steps is “0” (0%), if the ratio of the synthesis of the gray values obtained from the pattern density is 60% of the original, the gray values are synthesized by the same 0% obtained by multiplying 60% by 0.0.

More specifically, the image selected and created by the maximum value selecting section 3408 is output without change. The information of the film thickness of a layer, such as an interlayer insulating film, can be used to change the ratio. For example, if the overall contrast decreases when the film thickness of the layer, such as the interlayer insulating film, is thick, the ratio in the synthesis can be reduced for, without limitation, the upper-layer edges, the lower-layer edges, and the overlap part edges. There can also be a method for creating a template by using the result of the step estimating section 2803 in switching the output of the image processing system for synthesizing the gray values obtained from the pattern density and the output of another image processing system without the use of the gray values obtained from the pattern density (i.e. the ratio of synthesis is 0%). The step state of the upper layer, the step state of the lower layer, and the step state of the overlap part can be externally obtained to set the obtained result.

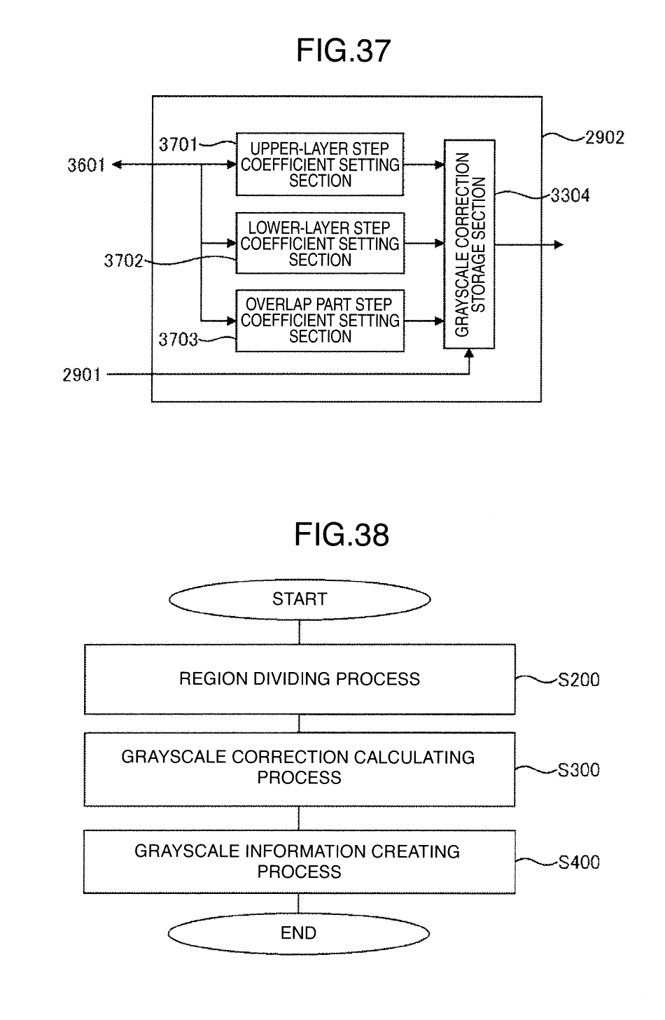

For example, when the user sets the state, the user uses a display section 3601 to set the step state of the upper layer, the step state of the lower layer, and the step state of the overlap part in the process as shown in FIG. 36. The set values are input to an adjusting section 3602, and the correction values corresponding to the set step states are output to the grayscale information creating section 2804. The adjusting section 3602 has a configuration similar to the configuration of the step estimating section 2803 as shown in FIG. 29. In this case, the grayscale correction calculating section 2902 has the configuration shown in FIG. 37. The values corresponding to the step state of the upper layer, the step state of the lower layer, and the step state of the overlap part set by the user are set to an upper-layer step coefficient setting section 3701, a lower-layer step coefficient setting section 3702, and an overlap part step coefficient setting section 3703, respectively. The gray scale correction storage section 3304 can be realized by a memory in the same way as the grayscale correcting section described in FIG. 33. The setting values of the upper-layer step coefficient setting section 3701, the lower-layer step coefficient setting section 3702, and the overlap part step setting section 3703 are stored as the correction values corresponding to the pixel positions of the upper-layer edge part, the lower-layer edge part, and the overlap part obtained by the region dividing section 2901. The grayscale information of each pixel can be created as in the grayscale information creating section 2804 described above.

Although there are two layers here, the same can be applied even if there are more than two layers.

FIG. 38 shows a processing flow of template creation.

In a region dividing process S200, each pattern is divided into a plurality of regions based on the design data. The patterns of an upper layer and a lower layer are used to obtain upper-layer pattern edges, lower-layer pattern edges, and lower-layer pattern edges overlapping the upper-layer pattern. Here, the content described in FIG. 3 is realized by a software process. In a grayscale correction calculating process S300, a grayscale correction value is obtained for each of the regions divided in S200 based on the process information. Here, the content described in FIG. 33 is realized by a software process.

In a grayscale information creating process S400, the grayscale correction value of each region obtained in the grayscale correction calculating process S300 is used to create grayscale information of each pixel of the template. Specifically, the content described in FIG. 34 is realized by software. The use of the foregoing method stably improves the matching success rate in all processes.

Although the template creating system has been described, the system can be used to create an image processing apparatus. A semiconductor inspecting apparatus including the image processing apparatus may also be formed.

In the execution of the software process, a personal computer may be used to execute the software process, or the software process may be incorporated into an LSI to execute a hardware process.

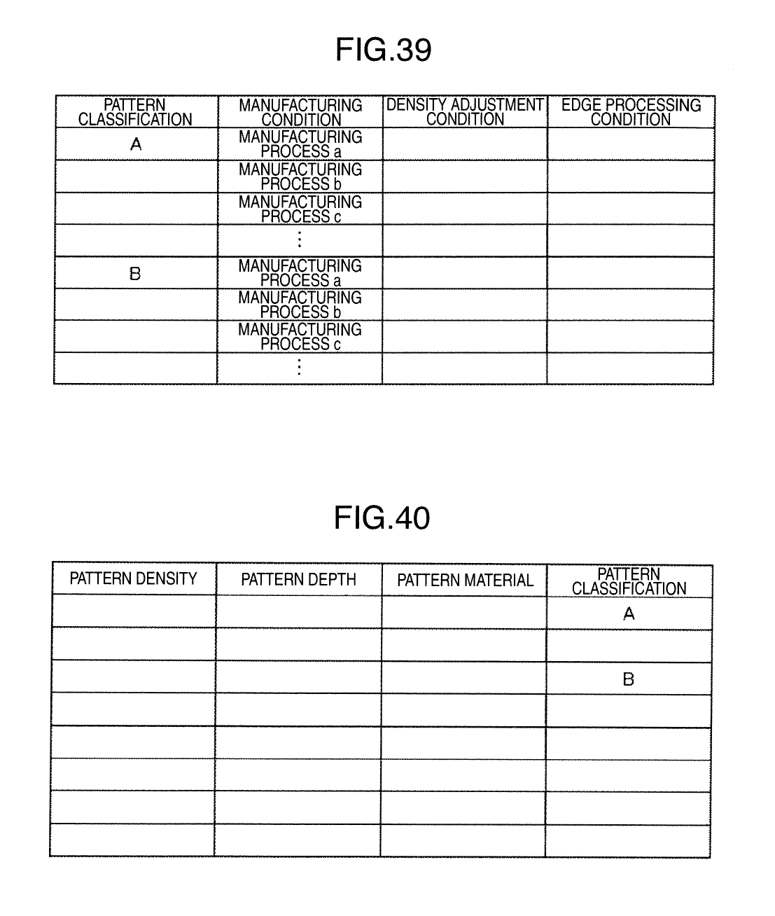

An example of forming in advance a table of a relationship between pattern conditions (classification of patterns), manufacturing processing information, and image processing conditions to read an image processing condition according to the region or the manufacturing process used in the OM image matching to use the image processing condition to create a template will be described. FIG. 39 is a diagram showing a table example showing a relationship between pattern classification, manufacturing processing information, density adjustment conditions of template, and edge processing conditions. If such a table is created in advance, the condition setting in the template creation based on the design data can be easily realized.

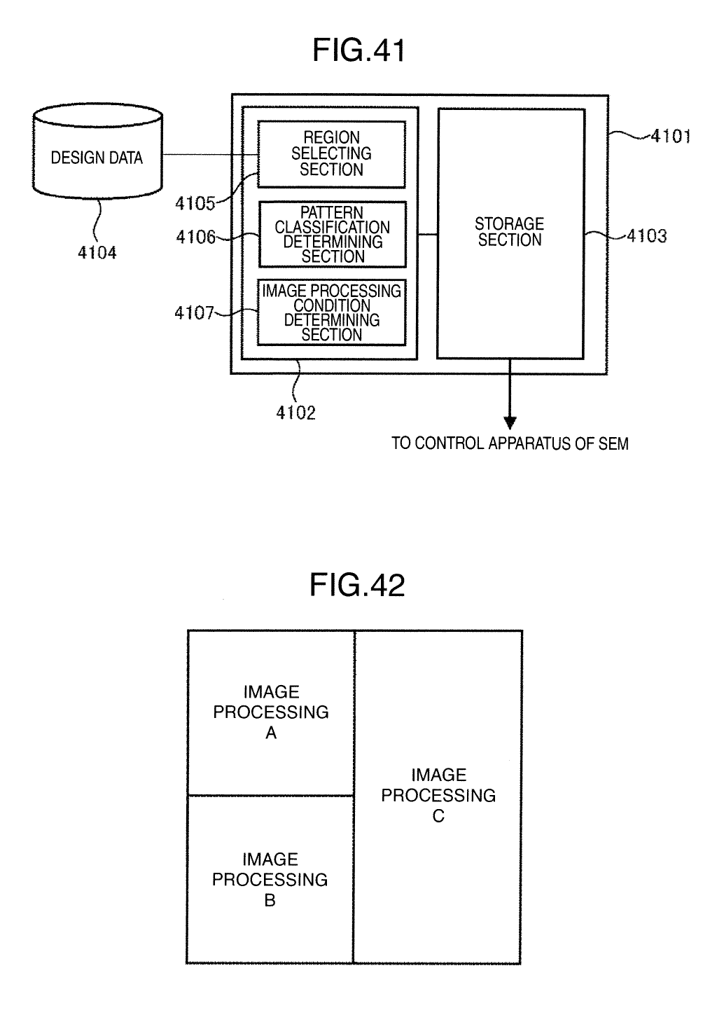

FIG. 40 is a diagram showing a table example showing a relationship between pattern conditions and pattern classification. The reflected light intensity when light is applied to the pattern may vary not only by the density of the pattern, but also by the height or the material of the pattern. In that case, the patterns can be classified according to some types of parameters related to the patterns as shown in FIG. 40, and a template based on accurate pattern information can be created. FIG. 41 is a diagram for explaining an example of a computation processing apparatus 4101 included in the condition setting apparatus 2403 or the like. The computation processing apparatus 4101 includes: a region setting section 4105 that sets a region as a target of an OM template on design data 4104; a pattern classification determining section 4106 that determines the pattern classification of the selected region; an image processing condition 4107 that determines the image processing condition of the selected design data region based on the pattern classification; and a storage section 4103 that stores tables as illustrated in FIGS. 39 and 40.

If the OM template includes a plurality of regions with different pattern conditions, different image processing may be applied to each of the different pattern condition regions as illustrated in FIG. 42.

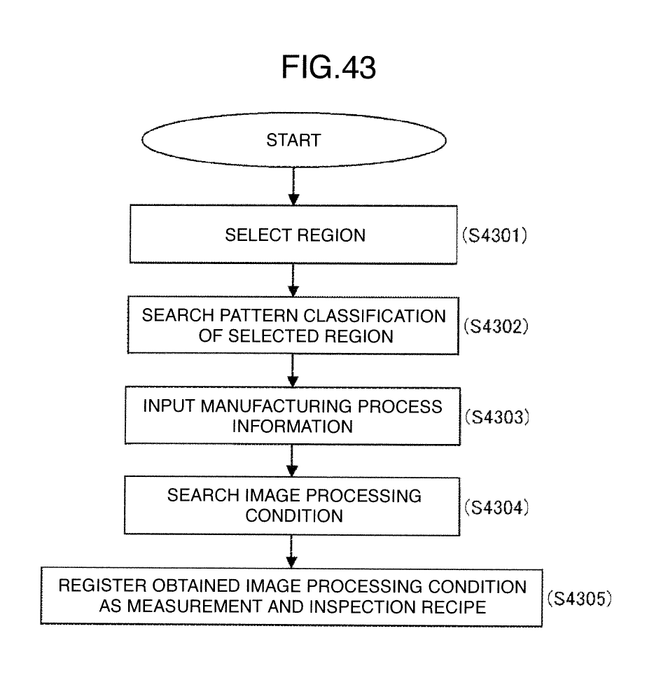

FIG. 43 is a flow chart showing a process of using two tables to set the image processing conditions of the OM template. First, a desired region on the design data is selected as a candidate of the OM template (step 4301). Pattern classification of the selected region is performed with reference to a table as illustrated in FIG. 40 (step 4302). Three pattern conditions (density, depth, and material) and pattern classification information are associated and stored in the table of FIG. 40. In a case of a line-and-space pattern, the density varies in relation to the pattern, space, or the pitch. Therefore, the values may be stored as pattern conditions. If a template can be properly formed, one condition (for example, only the pattern density) may be registered. Obviously, the patterns may be classified based on four or more conditions.

In the present embodiment, the pattern density is also an index of the brightness or contrast reduction. Therefore, parameters that significantly affect the change in the brightness or contrast (for example, statistics of interval between patterns, distance between segments included in the selected region, distance between adjacent closed figures, and distance between a plurality of closed figures) may be defined as the pattern density.

Information related to the manufacturing process for performing OM matching is input (step 4303), and the image processing conditions are searched based on the input information and the pattern classification information (step 4304). In the table illustrated in FIG. 39, the density adjustment conditions and the edge processing conditions are stored as adjustment conditions of the template image. As described, the brightness decreases at the part where the pattern is densely formed. Therefore, conditions that reduce (darken) the density with an increase in the density of the pattern are registered in the field of the density adjustment conditions. If a part of the image becomes dark, the edges (part that becomes dark in the OM image) existing there disappear. Therefore, conditions for setting the contrast close to the OM image can be registered in the field of the edge processing conditions.

Although the example of storing two types of image processing conditions is described in the present embodiment, the arrangement is not limited to this. Any type of image processing method for approximating the design data to the OM image can be used, and one or more types of processing conditions can be stored. The example of using two tables including the table for associating and storing the pattern classification and the pattern conditions (FIG. 40) and the table for associating and storing the pattern classification and the image processing conditions (FIG. 39) is described in the present embodiment. However, a table for directly associating and storing the pattern conditions and the image processing conditions may be used to search the image processing conditions.

In this way, the searched image processing conditions are registered in the storage section 4103 as a recipe for measurement and inspection (step 4305).

According to the configuration, the template region can be set on the pattern shape information obtained from the design data, simulation, or the like to appropriately form the template for OM matching.

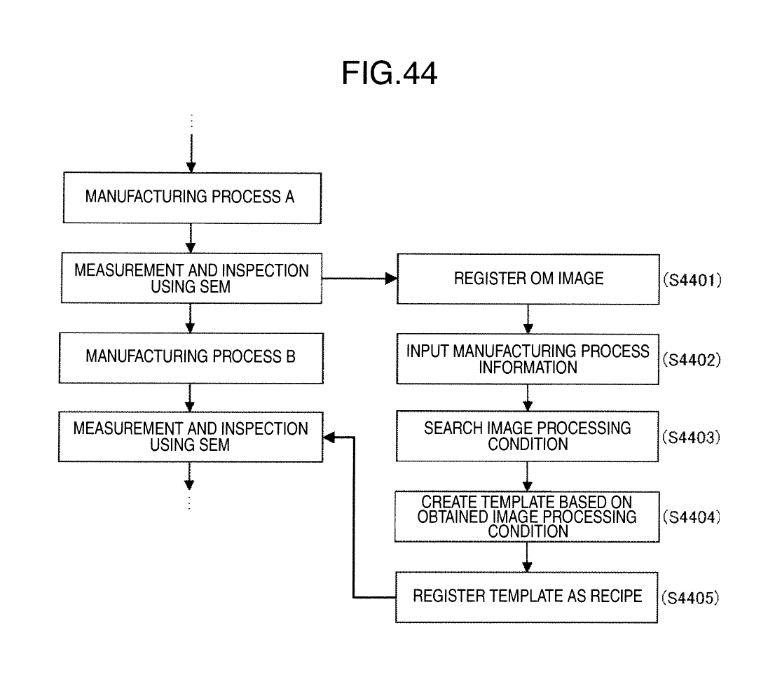

Although the example of acquiring the formation conditions of the template based on the design data or the simulation image has been mainly described, if a relationship between the OM image obtained after a manufacturing process and the OM image obtained after another manufacturing process is clear, the OM image obtained after one manufacturing process allows creating the template for OM matching used for the measurement and inspection after another manufacturing process. FIG. 44 is a flow chart showing a process of creating a template for an OM image used for measurement and inspection after a manufacturing process based on an OM image obtained in a measuring and inspecting process after another manufacturing process. An OM image obtained in a measuring and inspecting process after a manufacturing process A is stored in the storage medium 4103 (step 4401). Manufacturing process information (manufacturing process information to be measured or inspected next) is input (step 4402). Image processing conditions are searched with reference to a table storing change information of image (modification information of image) of a pattern formed in the manufacturing process A and a pattern formed in a manufacturing process B (step 4403). A template is created based on the obtained image processing conditions (step 4404). The template is registered in the storage section 4104 as a recipe (step 4405).

According to the configuration, images acquired after different manufacturing processes can be used to create a template, and an effort for creating the template can be reduced.

### REFERENCE SIGNS LIST

1 design data storage section
2 template creating section
3 edge density calculating section
4 region selecting section
5 image processing apparatus
6 display section
21 drawing section
22 image creating section
31, 33, 231, 232 edge detecting sections
32, 35 density detecting sections
34, 36, 236 maximum value selecting sections
41, 212, 342 storage sections
42 sparse region detecting section
43 dense region detecting section
44 determining section
45 region information section
211 in-pattern paint-out section
230 smoothing section
233, 234, 238, 421, 431 signal inverting sections
235, 422 minimum value selecting sections
237 density calculating section
239 synthesizing section
341, 423, 433, 445, 446 comparing sections
424 white region detecting section
425, 432, 441, 442 thresholds
434 black region detecting section
443, 444 counters
447 AND

1. A method for creating a template for template matching, the template created by partially extracting part of design data, the template created based on the extracted partial region, wherein
an edge density of edges that belong to a predetermined region in the design data equivalent to a region to be searched for in the template matching is calculated.

2. The method for creating a template according to claim 1, wherein
if information related to the density of the edges satisfies a predetermined condition, the predetermined region is selected as a template or a template candidate.

3. The method for creating a template according to claim 2, wherein
if a region determined to have a high edge density and a region determined to have a low edge density are included in the predetermined region at a predetermined ratio, the predetermined region is selected as a template or a template candidate.

4. The method for creating a template according to claim 1, wherein
if information related to the edge density satisfies a predetermined condition, one or both of binary and multi-valued templates are created based on the design data of the predetermined region.

5. The method for creating a template according to claim 1, wherein
if information related to the edge density satisfies a predetermined condition, one or both of a coordinate position and a region size of the predetermined region are registered as template information based on the design data of the predetermined region.

6. The method for creating a template according to claim 1, wherein
the edge density is calculated for the template stored in an operation program for performing template matching using the template.

7. The method for creating a template according to claim 6, wherein
suitability of the template is determined based on the calculation of the edge density.

8. The method for creating a template according to claim 1, wherein
the template is for performing the template matching on an image obtained by an optical microscope.

9. An image processing apparatus comprising a template creating section that creates a template for template matching based on selection of a partial region of design data,
the image processing apparatus comprising an edge density calculating section that calculates an edge density of edges that belong to a predetermined region in the design data equivalent to a region to be searched for in the template matching.

10. The image processing apparatus according to claim 9, wherein
the template creating section selects the predetermined region as a template or a template candidate if information related to the density of the edges satisfies a predetermined condition.

11. The image processing apparatus according to claim 10, wherein
the template creating section selects the predetermined region as a template or a template candidate if a region determined to have a high edge density and a region determined to have a low edge density are included in the predetermined region at a predetermined ratio.

12. The image processing apparatus according to claim 9, wherein
the template creating section creates one or both of binary and multi-valued templates based on the design data of the predetermined region if information related to the edge density satisfies a predetermined condition.

13. The image processing apparatus according to claim 9, wherein
the template creating section registers one or both of a coordinate position and a region size of the predetermined region as template information based on the design data of the predetermined region if information related to the edge density satisfies a predetermined condition.

14. The image processing apparatus according to claim 9, wherein
the edge density calculating section calculates the edge density for the template stored in an operation program for performing the template matching using the template.

15. The image processing apparatus according to claim 14, wherein
suitability of the template is determined based on the calculation of the edge density.

16. The image processing apparatus according to claim 9, wherein
the template is for performing the template matching on an image obtained by an optical microscope.

17. A computer program for causing a computing apparatus to create a template for template matching based on selection of a partial region of design data,
the computer program causing the computing apparatus to compute an edge density of edges that belong to a predetermined region in the design data equivalent to a region to be searched for in the template matching.

18. An image processing apparatus that creates a template for template matching from design data,
the image processing apparatus comprising a grayscale information creating section that uses design data and process information related to a manufacturing process to obtain grayscale information of each position in the template.

19. The image processing apparatus according to claim 18, further comprising
a step estimating section that creates information related to steps in the template based on the design data, wherein the grayscale information creating section obtains the grayscale information based on the information related to the steps.

20. The image processing apparatus according to claim 19, wherein
the step estimating section comprises a region dividing section that divides a region specified by the template into a plurality of regions, and the region dividing section carries out the region division based on the design data and the process information.

21. The image processing apparatus according to claim 20, wherein
the step estimating section divides the region based on the design data of a pattern of a multi-layer structure.

22. An image processing apparatus comprising a template creating section that creates a template for template matching based on selection of a partial region of design data, wherein
the template creating section creates the template by applying image processing to a plurality of regions included in the partial region of the design data according to a formation state of a pattern.

23. The image processing apparatus according to claim 22, wherein
the template creating section applies the image processing to the plurality of regions according to information related to a density of the pattern of the plurality of regions.

24. A computer program for causing a computing apparatus to create a template for template matching based on selection of a partial region of design data,
the computer program causing the computing apparatus to create the template by applying image processing to a plurality of regions included in the partial region of the design data according to a formation state of a pattern.
